(19) United States
(12) Patent Application Publication
(10) Pub. No.: US 2023/0202151 A1
(43) Pub. Date: Jun. 29, 2023

(54) TRANSFER PRODUCT AND METHOD FOR RECYCLYING A TRANSFER PRODUCT

(71) Applicant: LEONHARD KURZ Stiftung & Co. KG, Fürth (DE)

(72) Inventor: Patrick Ortmann, Nürnberg (DE)

(21) Appl. No.: 17/920,127

(22) PCT Filed: Apr. 14, 2021
(86) PCT No.: PCT/EP2021/059645

§ 371 Date: Oct. 20, 2022

(30) Foreign Application Priority Data
Apr. 23, 2020 (DE) 10 2020 111 105.3

(51) Int. Cl. B32B 27/06

(52) U.S. Cl. CPC B32B 27/06; B44C 1/1729

(57) ABSTRACT

The invention describes a process for recycling a transfer product (1) and a transfer product (1) suitable for it having a non-water-soluble carrier film (2) and a non-water-soluble transfer ply (4) at least partially arranged on the carrier film (2), wherein a water-soluble detachment layer (3) is arranged between the carrier film (2) and the transfer ply (4) and wherein the following step is carried out in the process:

x) dissolving the water-soluble detachment layer (3) by means of a washing liquid (6), preferably in a washing liquid bath, wherein the transfer ply (4) is detached from the carrier film (2).

The invention relates to a transfer product and a process for recycling a transfer product.

It is known to use stamping films to decorate surfaces. For example, using coating processes, varnish layers dyed or provided with dyes or pigments and/or, using vapor deposition processes, metal layers are applied to a carrier film for this purpose. The transfer ply is then applied to the surface to be decorated together with the carrier film. Depending on the process, the adhesion between the surface to be decorated and the transfer ply is produced by means of a thermally activated primer layer or an adhesive layer applied to the surface to be decorated. When the carrier film is subsequently peeled off, the transfer ply remains on the surface to be decorated and is detached from the carrier film in the area to be decorated. In order to make it possible to detach the transfer ply from the carrier film in the area to be decorated, detachment layers are arranged between the transfer ply and the carrier film in the stamping films. In particular, non-water-soluble waxes, which soften at higher temperatures, are used for such detachment layers and thus the adhesive force between transfer ply and carrier film are reduced in a targeted manner.

In areas not to be decorated, the transfer ply is peeled off again with the carrier film. In the case of areas to be decorated which are only small, such as for example in the form of fine characters or line motifs, large quantities of the transfer ply remain on the carrier film as residual transfer ply. A further use of such a transfer product in a stamping run again is generally not possible or only possible in quite specific application machines and/or by means of quite specific application processes. The used carrier film with residual transfer ply must in all cases be disposed of, at times expensively. A re-use is sometimes only achieved by energy recovery, for example in the production of refuse-derived fuels. This applies similarly to the recovery of the material of a carrier film from a transfer film which has been produced with defects and thus represents a reject.

Recycling techniques for the recovery of the material of the carrier film, such as for example mechanical processes or the use of strong shear forces to separate the transfer ply from the carrier film, are often effected with a high energy consumption, low throughput or only incomplete detachment of the transfer ply as well as the detachment layer from the carrier film. An unmixed recovery of the carrier film is thus not possible or only possible with substantial effort, as small proportions of mixed contamination often already result in substantial deficiencies in the quality of the recycling product. Further, for example because of the use of relatively large mechanical forces to separate the transfer ply from the carrier film, particles are split off, which adhere to the material of the carrier film or contaminate liquids which are used to clean the carrier film. The liquids are filtered or disposed of, at times expensively, because of the particles of the carrier film, detachment layer and transfer ply contained therein.

The object of the invention is now to specify an improved transfer product with an improved recyclability and an improved process for recycling a transfer product.

The object is achieved by a transfer product, in particular by a recyclable transfer product. The transfer product has a non-water-soluble carrier film and a non-water-soluble transfer ply arranged at least partially on the carrier film. A water-soluble detachment layer is arranged between the carrier film and the transfer ply.

Thus, besides the water-soluble detachment layer, the transfer product has in particular no further water-soluble layers. The transfer product is preferably a transfer film, in particular a hot-stamping film and/or a cold-stamping film and/or a thermotransfer film, or has been used as such.

The object is further achieved by a process for recycling a transfer product. The transfer product has a non-water-soluble carrier film and a non-water-soluble transfer ply arranged at least partially on the carrier film, wherein a water-soluble detachment layer is arranged between the carrier film and the transfer ply. The following step is carried out in the process:

x) dissolving the water-soluble detachment layer by means of a washing liquid, preferably in a washing liquid bath, wherein the transfer ply is detached from the carrier film.

The transfer product according to the invention is preferably used in the process according to the invention for recycling a transfer product.

Such a transfer product and recycling process result in the advantage, in particular over energy recovery, that the recycled material of the carrier film can be used to produce new carrier film. It is also conceivable that the recycled plastic can be used for the production of other plastic products, for example injection-molded parts and/or extrusion parts. It is preferably provided that the transfer product is recycled both after an application process and when produced as rejects. It is possible here for the material of the carrier film to be recycled such that the resulting end product can be processed in further steps and has particularly good material properties.

In particular, the recyclability of the transfer product is improved here, as the use of a water-soluble detachment layer between carrier film and transfer ply makes a comparatively clean, simple and/or cost-effective recycling of a transfer product possible. The transfer product here is in particular a transfer product which is recyclable in water.

By recyclability and recyclable is meant here in particular that all layers deposited on the carrier film can be completely detached again in a recycling process. In particular, the transfer ply can be removed from the carrier film residue-free.

In the case of recycling by means of the washing liquid, preferably water, a targeted separation of the transfer ply from the carrier film is made possible by the complete dissolution of the water-soluble detachment layer. In step x), in particular, the carrier film is thus cleaned and the transfer product is thus released from the transfer ply.

It is thereby possible in particular for a particularly pure material of the carrier film to be recovered. A particularly unmixed reprocessing of the carrier film for a further use or recovery of the material of the carrier film is thus advantageously made possible, which can for example also be re-used in further chemical or mechanical recycling steps. Contaminations, for example due to the material of the transfer ply or the water-soluble detachment layer, which result in deficiencies in the quality of the recycling product or recyclate, are advantageously reduced or prevented.

In addition, the transfer ply is preferably detachable as a layer structure through the dissolution of the water-soluble detachment layer, wherein the layer structure is then present in particular as a cohesive solid in the washing liquid. Thus, advantageously, in particular in terms of a solubility in the washing liquid, no substances can be dissolved out of the transfer ply. While the water-soluble detachment layer remains in the washing liquid as a homogeneous solution, the detached insoluble transfer ply forms in particular a heterogeneous mixture with the washing liquid. The advantage is hereby achieved that substances which would no longer be able to be filtered out of the washing liquid, or in particular only with increased effort, can be reduced or avoided.

The shape of the detached transfer ply here is preferably only dependent on the shape of the transfer ply before the water-soluble detachment layer is dissolved and can be determined by an optional preceding application process or a further shaping process used in a targeted manner. The detached transfer ply can thus be handled particularly easily. For example, a separate disposal of remaining transfer ply after use of the transfer product is also made possible or easier in the case of transfer not over the whole surface during the application process or in the case of rejects. The transfer ply separated by the washing liquid, for example in the form of transfer ply constituents and/or transfer ply particles with a preferably heterogeneous composition, can for example also be processed in further chemical separation processes, and in particular in separation processes optimized for the transfer ply.

Advantageous embodiments of the invention are described in the dependent claims. By a layer, by a ply and by a film is meant in particular a substantially two-dimensional structure which is in turn monolayer or multilayer. A film is preferably self-supporting. A layer or a ply is for example self-supporting or not self-supporting.

By a transfer product is meant in particular both a transfer product before its application, for example in an application process, in particular a transfer process and/or laminating process and/or insert-molding process and/or in-mold decoration process, to a substrate or target object and the part of a transfer film not transferred to the substrate or target object after the application, as well as rejects. In the case where the transfer ply of the transfer product has been at least partially transferred to a substrate to be decorated, for example a component or a sheet material or a roll material, the transfer product then has in particular a carrier film with a residual transfer ply arranged thereon. The residual transfer ply describes the part of the transfer ply which has not been transferred to the substrate to be decorated and thus still remains on the carrier film. In the case of the rejects, the transfer ply remains in particular completely on the carrier film. The proportion by weight of the transfer ply relative to the carrier film is preferably larger in the case of rejects than in the case of already transferred transfer ply. It is thus preferably provided that, with the process, the transfer ply, in particular for example in the form of residual transfer ply, which is to be regarded essentially as foreign material, is removed from the carrier film.

Further, by the transfer product is meant in particular also a number of transfer product shreds, which are generated for example by a shredding of a transfer product. In particular, in step x) the carrier film of the transfer product is guided through the washing liquid in its entirety, thus preferably in one piece, or preferably carrier film shreds, which are comprised by the transfer product shreds, are put into the washing liquid. In particular, it is also conceivable that, instead of only one transfer product, several transfer products, in particular transfer products of the same type or of similar types, preferably at least with carrier film of the same type, are used in the process for recycling a transfer product. The transfer ply is preferably present at least in areas on the carrier film and/or on the carrier film shreds before step x). By the carrier film is therefore preferably meant both the carrier film in its entirety and a number of carrier film shreds. By the transfer ply is preferably meant both the transfer ply in its entirety and a number of transfer ply constituents.

In particular, it is thus possible for the transfer product shreds to comprise or consist of carrier film shreds with transfer ply constituents. Further, it is possible for the transfer ply constituents to comprise varnish residues and/or varnish dusts and/or fine material. By fine material is preferably meant particles which are coarser than dust particles, but smaller than transfer product shreds and/or carrier film shreds.

It is possible in particular that after step x) the transfer product, in particular the carrier film and/or the material of the carrier film, has a purity in the range of from 60.0 wt.-% to 100.0 wt.-%, preferably from 95.0 wt.-% to 100.0 wt.-%, particularly preferably from 99.0 wt.-% to 100.0 wt.-% (wt.-%=percent by weight=proportion of the weight in percent of the total weight). The specification of the purity is preferably based on the proportion by mass of the material of the carrier film.

The purity of the transfer product is preferably based on the proportion of the main constituent of the carrier film in the transfer product. The purity of the transfer product can thus be improved in particular by a removal of at least the transfer ply and the water-soluble detachment layer from the carrier film. The purity of the transfer product, in particular the transfer product shreds, is preferably improved successively from step to step. The transfer ply and/or the transfer ply constituents of the transfer product are preferably regarded as foreign material in particular in the recycling process.

In particular, it is provided that the transfer product has a foreign material proportion before step x) in the range of from 0 wt.-% to 50 wt.-%, preferably from 0 wt.-% to 20 wt.-%, and/or has a foreign material proportion after step x) in the range of from 0 wt.-% to 5 wt.-%, preferably from 0 wt.-% to 1 wt.-%, particularly preferably of approximately 0 wt.-%.

After step x) the transfer product preferably has a varnish residue proportion in the range of from 0 wt.-% to 5 wt.-%, preferably from 0% to 1 wt.-%, particularly preferably of approximately 0 wt.-%. By varnish residue proportion is preferably meant the proportion of material of the transfer ply still present in the transfer product relative to the material of the transfer ply applied in the production process, in particular wherein the varnish residue proportion is reduced through the application of the transfer ply and/or steps of the recycling process. Further, it is possible for the transfer product to have a fine material proportion after step x) in the range of from 0 wt.-% to 5 wt.-%, preferably from 0 wt.-% to 1 wt.-%, particularly preferably of approximately 0 wt.-%.

In particular, the transfer product preferably has substantially no, or only very few, transfer ply constituents after step x).

Further, it is possible for the transfer product, in particular the carrier film and/or the material of the carrier film, to be colorless, transparent, crystal clear, opaque, dyed, at least partially dyed or colored after step x).

In step x) the washing liquid is in particular formed of a homogeneous solution of a starting liquid and the water-soluble detachment layer. The composition of the washing liquid is preferably selected depending on the transfer product, in particular the transfer ply. The water-soluble detachment layer is thus advantageously dissolved by the washing liquid, but further components of the transfer product, in particular the transfer ply, are not dissolved and as a result can for example be better processed, in particular filtered, in subsequent steps. Water, or alternatively a homogeneous mixture of water with one or more further substances, is preferably used as starting liquid for the washing liquid, in particular before step x). In particular, one or more alcohols, preferably selected from methanol, ethanol, n-propanol, isopropanol or mixtures thereof, and/or acetone are used as one or more further substances. Further, it is possible to add additives and/or surfactants, such as for example defoamers, to the washing liquid. If the washing liquid and/or its starting liquid is water, this water preferably does not have any further additives and/or is untreated water.

The transfer ply detached from the carrier film in step x) is present, in particular after step x), preferably in the form of transfer ply constituents in the washing liquid. The transfer ply constituents are present in particular in undissolved form in the washing liquid and/or the transfer ply constituents in the washing liquid cohesively have the entire layer structure of the transfer ply of the transfer product, in particular of the transfer product before the recycling process or before step x). In other words, it is possible in particular for the layer structure of the transfer ply of the transfer product to be preserved during step x), as the transfer ply is insoluble in the washing liquid. In particular, the transfer ply and/or the carrier film have the same layer structure before step x) and after step x).

Advantageously, the transfer ply constituents in the washing liquid, in particular after step x), preferably have a particle size in a range of from 10 μm to 5 mm, preferably in a range of from 20 μm to 5 mm. By the particle size is meant in particular the maximum or largest distance between two points of a particle, in particular transfer ply constituents.

An optional separation of the transfer ply and/or the carrier film into smaller constituents, which in particular form smaller transfer ply particles and/or smaller carrier film particles, is conceivable, in particular through mechanical forces, before, during and/or after step x). In particular, such mechanical forces are exerted in a targeted manner in shredding steps or also unintentionally in other steps.

It is possible in particular for the washing liquid with the transfer product particles to be present as a preferably compact and stable suspension, preferably with particles with the above-named particle sizes. Advantageously, fine particles, which would require expensive separation steps, such as for example an expensive filtration, are hereby not present in the washing liquid or preferably only to a very small extent. As a result, in particular the maintenance and repair effort and the process reliability are improved. Further, fine particles are in particular prevented from sticking to the carrier film and thus the purity of the recyclate is improved. The water-soluble detachment layer advantageously makes this possible in that it is possible to use no or particularly small mechanical forces, which would cause such fine particles, in particular to separate the transfer ply from the carrier film in step x).

In particular, 99 wt.-% to 100 wt.-% of particles undissolved in the washing liquid, in particular comprising foreign substances, the smaller carrier film particles, the smaller transfer ply particles and/or the transfer ply constituents, advantageously have a particle size in a range of from 10 μm to 5 mm, preferably in a range of from 20 μm to 5 mm, particularly preferably in a range of from 50 μm to 5 mm.

It is expedient that during and/or after step x) the washing liquid with the transfer product consists of the carrier ply and the transfer ply with a concentration, in particular solids concentration, in a range of from 0.1 wt.-% to 25 wt.-%, preferably from 1 wt.-% to 10 wt.-%. The concentration is calculated in particular from the ratio of the sum of the weight of carrier ply and transfer ply present in the washing liquid to the weight of the washing liquid with the water-soluble detachment layer dissolved in the washing liquid, with the carrier film and with the transfer ply.

In particular, it is also possible for the proportion of transfer product shreds in the washing liquid in step x) to lie in a range of from 0.1 wt.-% to 25 wt.-%, preferably from 1 wt.-% to 10 wt.-%.

The carrier film has in particular a layer thickness in a range of from 3 μm to 100 μm, preferably in a range of from 4.5 μm to 12 μm. The carrier film is preferably colorless, transparent, crystal clear, opaque, dyed, at least partially dyed or colored. The carrier film has been or is preferably produced by means of extrusion, in particular flat film extrusion. In particular, the carrier film preferably comprises biaxially oriented polyester or consists of polyester. The carrier film preferably comprises or consists of one or more components or composite materials selected from polyethylene terephthalate (PET), polylactide, polyethylene furanoate, polybutylene terephthalate, polytrimethylene terephthalate, polyethylene naphthalate, and/or from polyethylene, polypropylene, polycarbonate, polyester carbonate, cellophane, cellulose acetate, polyvinyl chloride, polystyrene, polyamide, polyimide, polyvinylidene chloride and/or paper, in particular coated and/or laminated paper. The carrier film expediently has a main constituent, wherein the proportion of the main constituent in the carrier film is more than 97%, preferably more than 99.9%, particularly preferably more than 99.97%. In order to improve the recyclability of the carrier film and also the material properties of the end product, it is preferably provided that the carrier material is present as pure as possible, i.e. no other foreign substances and/or plastics which are different from the carrier material are present. The main constituent of the carrier film is in particular PET.

Such properties are exhibited by the carrier film in particular in the transfer product before the process for recycling the transfer product and preferably during the process for recycling the transfer product preferably before step x).

The transfer ply has in particular at least one layer or a combination of layers of the following layers: non-water-soluble detachment layer, protective varnish layer, metal layer, color layer, adhesive layer, primer layer, adhesion-promoting layer. The transfer ply here preferably has one or more of the above layers in the specified order starting from the side of the transfer ply facing the water-soluble detachment layer.

It is expedient that the protective varnish layer has a layer thickness in a range of from 0.5 μm to 15 μm, preferably from 0.8 μm to 10 μm, preferably from 0.8 μm to 2 μm. A layer thickness of from 0.8 μm to 2 μm is preferably expedient in the case of a transfer product with a metal layer. A layer thickness of from 0.8 μm to 10 μm is preferably expedient for a transfer product without metal layer.

Further, it is possible for the protective varnish layer to contain binders selected from nitrocellulose, polyurethanes, polyacrylates and copolymers thereof, polymethacrylates and copolymers thereof, polyester resins, styrene resins, maleic acid anhydride-based resins, hydrocarbon resins, shellac, alkyd resins, colophony resins, maleic resins, melamine resins, formaldehyde resins, ethylene-vinyl acetate copolymers, polybutyral, polyamides, plasticizers or a combination of two or more of these components.

The protective varnish layer in particular makes a protection against mechanical and/or chemical loading of the transfer ply possible. The protective varnish layer is preferably crystal clear colorless. Further, it is possible for the protective varnish layer to be dyed with soluble dyes and/or organic and/or inorganic color pigments and/or provided with matting agents. In combination with a subsequent metal layer in the case of a metallized transfer product, a metallic gloss effect is generated for example. In the case of non-metallized transfer products, pigments are preferably used in order to be able to achieve in particular an intense covering power of the transfer ply relative to the substrate surface.

The metal layer preferably has a layer thickness in a range of from 5 nm to 50 nm, preferably from 10 nm to 15 nm. In particular, the metal layer comprises or consists of aluminum, chromium, silver, gold, copper, nickel, tin, indium or alloys of at least two of these metals and/or one or more compounds, preferably with high refractive indices, selected from silicon oxide, magnesium oxide, titanium oxide, aluminum oxide, zinc oxide or zinc sulfide. Here, it is possible for the metal layer to be mono- or multilayer.

The primer layer has in particular a layer thickness in a range of from 0.1 μm to 5 μm, preferably in a range of from 0.5 μm to 3 μm and/or in a range of from 0.1 μm to 0.5 μm. A layer thickness in a range of from 0.1 μm to 0.5 μm is expedient in particular if the transfer product is a cold-stamping film. A layer thickness in a range of from 0.5 μm to 3 μm is expedient in particular if the transfer product is a hot-stamping film. By means of the primer layer, it is possible for a sufficient adhesion of the transfer ply to the substrate or the target object to be guaranteed preferably during the application process and in particular also after the application process. Preferably, the primer layer comprises or preferably consists of one or more of the following materials: polyurethanes, polyesters, polyamides, polycarbonates, polyureas, polyacrylates and/or copolymers thereof, polymethacrylates and/or copolymers thereof, hydrocarbon resins, shellac, alkyd resins, colophony resins, ketone resins, phenolic resins, polystyrene resins, epoxy resins, maleic resins, melamine resins, formaldehyde resins, polyvinyl acetates, ethylene-vinyl acetate copolymers, polyvinyl chloride, nitrocellulose, polyolefins, modified polyolefins and/or plasticizers and/or dyes and/or organic and/or inorganic pigments and/or matting agents.

It is also possible, in particular in the case of a transfer product with high proportions of dyes and/or pigments and/or matting agents in the protective varnish layer, for one or more additional adhesion-promoter layer(s) to be inserted between protective varnish layer and metal layer and/or protective varnish and primer layer in the case of transfer products with metal layer, or between protective varnish layer and primer layer in the case of transfer production without metal layer. These have in particular a layer thickness of from 0.01 μn to 0.5 μm, preferably in a range of from 0.01 μm to 0.3 μm. The adhesion-promoting layer and/or the one or more additional adhesion-promoter layer(s) comprise or preferably consist of one or more of the following materials: polyurethanes, polyesters, polyamides, polycarbonates, polyureas, polyacrylates and/or copolymers thereof, polymethacrylates and/or copolymers thereof, hydrocarbon resins, shellac, alkyd resins, colophony resins, ketone resins, phenolic resins, polystyrene resins, epoxy resins, maleic resins, melamine resins, formaldehyde resins, polyvinyl acetates, ethylene-vinyl acetate copolymers, polyvinyl chloride, nitrocellulose, polyolefins, modified polyolefins and/or plasticizers.

The properties described for the transfer ply and its layers are exhibited by the transfer ply in particular in the transfer product before the process for recycling the transfer product as well as, preferably during the process for recycling the transfer product, by the transfer ply preferably before and/or after step x).

In step x) the washing liquid soaks into the transfer product for example via cut edges and/or broken edges and/or diffuses through non-water-soluble transfer ply layers and begins to dissolve the water-soluble detachment layer on contact with it.

The water-soluble detachment layer has in particular a layer thickness in a range of from 0.01 μm to 1 μm, preferably in the range of from 0.05 μn to 0.3 μm. Further, it is possible for the water-soluble detachment layer to contain one or more water-soluble compounds, preferably one or more polymers and/or oligomers. Such polymers and/or oligomers are preferably selected from polyvinyl alcohol, polyvinyl pyrrolidone, carboxymethyl cellulose, methyl cellulose, polyols, starch, saccharides, gum arabic, gelatin, lipids, polyethylene oxide, polyvinyl butyral, polyester, polyurethane, polyacrylic acid and/or polyamide. It is possible for the water-soluble detachment layer to have a combination of these polymers and/or oligomers. The water-soluble detachment layer preferably contains polyvinyl alcohol, in particular produced from partially saponified polyvinyl acetate with degrees of saponification in a range of from 75% to 100%.

It is further conceivable that the water-soluble detachment layer has one water-soluble layer or several water-soluble layers. Such properties are exhibited by the water-soluble detachment layer in particular in the transfer product before the process for recycling the transfer product as well as preferably during the process for recycling the transfer product preferably before step x).

It is moreover expedient that a non-water-soluble detachment layer is arranged between the non-water-soluble transfer ply and the water-soluble detachment layer. The non-water-soluble detachment layer has in particular a layer thickness in a range of from 0.01 μm to 0.5 μm, preferably in the range of from 0.01 μm to 0.2 μm. The non-water-soluble detachment layer is preferably produced from wax, in particular based on one or more of the following components: polyethylene, polypropylene, fats, fatty acids and derivatives thereof, lipids, long-chain alcohols, one or more fluorinated compounds, in particular polytetrafluoroethylene, polyvinylidene fluoride and/or fluorinated fatty acids, modified and/or unmodified silicone waxes and/or resins.

In particular, the non-water-soluble detachment layer improves the transfer of the transfer ply in an application process, for example in a transfer process and/or laminating process and/or in-mold decoration process, to a substrate surface, preferably by thereby reducing the detachment force for detaching the transfer ply from the carrier film.

The non-water-soluble detachment layer preferably is not or has not been produced on an aqueous basis and/or in particular has no aqueous dispersion. It is further conceivable that the non-water-soluble detachment layer has one non-water-soluble layer or several non-water-soluble layers. By means of the non-water-soluble detachment layer, it is in particular also guaranteed that the washing liquid merely forms a homogeneous solution with the water-soluble detachment layer.

Such properties are exhibited by the non-water-soluble detachment layer in particular in the transfer product before the process for recycling the transfer product as well as preferably during the process for recycling the transfer product preferably before step x).

By water-soluble is meant in particular that the water-soluble detachment layer, in particular during step x), can be completely dissolved in the washing liquid, in particular in water. By non-soluble is meant in particular that at most 1 g material per 1,000 g liquid, preferably 0.1 g material per 1,000 g liquid, of a non-soluble material is present dissolved in the liquid. By non-water-soluble is meant here in particular that, preferably after step x), at most 1 g dissolved transfer ply per 1,000 g washing liquid, in particular water, preferably 0.1 g dissolved transfer ply per 1,000 g washing liquid, in particular water, is present. Here, the temperature of the dissolved material, preferably the dissolved transfer ply, and the liquid, preferably the washing liquid, is preferably room temperature, in particular in a range of from 15° C. to 25° C.

In particular, in an application process the water-soluble detachment layer and/or the non-water-soluble detachment layer is partially or completely transferred with the transfer ply to the substrate and detached from the carrier film and/or is partially or completely detached from the transfer ply and peeled off the transfer ply with the carrier film.

It is further possible for the water-soluble detachment layer and/or the non-water-soluble detachment layer to be present in areas in which the transfer ply is not present after the application process. Further, it is possible for the water-soluble detachment layer and/or the non-water-soluble detachment layer not to be present in areas in which the transfer ply is not present after the application process. The water-soluble detachment layer and/or non-water-soluble detachment layer transferred to a substrate with the transfer ply preferably has a high level of transparency, in particular a transmittance of from 95% to 100%, preferably in a wavelength range of from 350 nm to 800 nm.

The transfer product, in particular as transfer film, is preferably produced by means of coating processes. In particular, the detachment layers, preferably the water-soluble detachment layer and/or the non-water-soluble detachment layer and/or the transfer ply, in particular the protective varnish layer and/or the primer layer, are applied to the carrier film via varnishing processes, such as for example gravure printing or flexographic printing or screen printing or inkjet printing. For this purpose, varnish systems based on organic solvents, water, or water/alcohol mixtures are used in particular, wherein the volatile components are evaporated after the coating, preferably by a drying process, and thus dry varnish layers are obtained. To produce the transfer product, solvents which comprise water are preferably used merely for the water-soluble detachment layer. The metal layer is preferably deposited in one or more layers by means of vapor deposition processes, in particular vacuum deposition.

In particular in a transfer process in the form of hot stamping, the transfer product, in particular the transfer film, and preferably the water-soluble detachment layer, particularly preferably a combination of water-soluble and non-water-soluble detachment layer, is preferably designed such that a clean stamping/detachment of the transfer ply from the carrier film is possible by means of pressure and temperature. In the case of hot stamping, the transfer ply is transferred to the substrate by the action of pressure and temperature by means of a stamping die. The shape of the stamping die represents in particular the decoration motif which is transferred to the substrate by the transfer ply. Application temperatures of preferably from 100° C. to 180° C. result in particular in the softening of the water-soluble detachment layer, and in particular the optional non-water-soluble detachment layer, and the primer layer, with the result that the primer layer generates an adhesion to the substrate, the adhesive force of which then exceeds the force for detaching the transfer ply from the carrier film. Here, the properties of the water-soluble detachment layer and also of the optional non-water-soluble detachment layer, the protective varnish layer and the primer layer are expediently designed in terms of their chemical and physical properties such that a clean stamping and a sharp-edged transfer of the transfer ply to the substrate is made possible.

In particular in a transfer process in the form of cold stamping, an adhesive layer in the shape of a decoration motif is deposited on the substrate preferably via a printing process, such as for example in particular offset printing and/or flexographic printing and/or screen printing and/or inkjet printing. The transfer product, in particular the transfer film, is then preferably applied to the substrate in a temperature range of from 10° C. to 40° C., preferably in a range of from 15° C. to 30° C., and then in particular the carrier film is peeled off. If the force of the adhesion of the adhesive layer to the transfer ply is larger than the force for detaching the transfer ply from the carrier film, the transfer of the transfer ply to the substrate results. When the carrier film is peeled off, the transfer ply thus remains on the substrate in particular in areas with the adhesive layer and is detached from the carrier film there. In particular, oxidatively and/or radiation-curing adhesives are used for the adhesive layer. The water-soluble detachment layer and the optional non-water-soluble detachment layer in combination with the protective varnish layer and the primer layer are preferably designed in terms of their chemical and physical properties such that a clean stamping and a sharp-edged transfer of the transfer ply to the substrate, in particular the areas with the adhesive layer, is made possible.

The layers applied to the carrier film, in particular the water-soluble detachment layer and/or the non-water-soluble detachment layer and the transfer ply, advantageously have a sufficient adhesion to one another and to the carrier film, in order in particular to prevent an uncontrolled detachment of the entire transfer ply or individual layers of it from the carrier film, for example during winding and unwinding, during transport or during storage. The force for detaching the transfer ply from the carrier film, in particular at temperatures in the range of from 15° C. to 35° C., preferably lies in a range of from 1 cN/cm to 10 cN/cm, preferably in the case of cold-stamping films preferably in the range of from 1 cN/cm to 3 cN/cm, and/or in particular in the case of hot-stamping films preferably in the range of from 2 cN/cm to 5 cN/cm.

The detachment forces between the individual transfer ply layers, in particular the protective varnish layer, the metal layer and/or the primer layer, are preferably larger than the force for detaching the transfer ply from the carrier film. As a result of this, in particular, a complete transfer of the transfer ply in areas to be transferred to the substrate is made possible in the application process. Further, a breaking or splitting of the transfer ply during the application process is prevented.

It is expedient that the preferably smallest detachment force within or between two or more layers of the transfer ply is at least twice as high as the force for detaching the transfer ply from the carrier film. In particular, the detachment force, preferably the smallest detachment force, within or between two or more layers of the transfer ply lies in a range of from 10 cN/cm to 100 cN/cm, preferably at least 20 cN/cm to 100 cN/cm, particularly preferably at least 40 cN/cm to 100 cN/cm.

For the measurement of the force for detaching the transfer ply from the carrier film, a double-sided adhesive tape is preferably stuck onto a rigid surface with a length of 25 cm and a width of 10 cm over the whole surface without bubbles. Then a strip of the transfer product, in particular the transfer film, preferably before the process for recycling the transfer film, with a length of 30 cm and a width of 10 cm is stuck on the adhesive tape with the transfer ply side without bubbles such that a tab of a 5-cm film overhang remains. The stuck-on transfer product, in particular the stuck-on transfer film, is pressed on firmly, the overhanging tab is secured to the measuring unit of a material testing machine of the Z005 type from ZwickRoell GmbH & Co. KG and the carrier film is peeled off at a peel angle of 90° and a speed of 50 cm/min. The force necessary in this case is measured and specified in cN per cm film width.

In particular, the water-soluble detachment layer and/or the non-water-soluble detachment layer serve to set the detachment force between transfer ply and carrier film.

Further, it is expedient if the carrier film and/or the transfer ply and/or the non-water-soluble detachment layer has one or more layers which are porous at least in areas and/or water-permeable at least in areas, in particular such that the transfer product and/or an at least section of the transfer product can be passed through by the washing liquid from at least one outer surface, which is preferably not formed by the water-soluble detachment layer, up to the water-soluble detachment layer. The dissolution of the water-soluble detachment layer in step x) is advantageously accelerated hereby, as a larger surface area of the water-soluble detachment layer can be brought into contact with the washing liquid.

Preferably, step x) is carried out by means of at least one cleaning device or a combination of cleaning devices, in particular selected from: stirred tank, washer, hot washer, friction washer, wet cutting device, and/or wet cutting mill.

The time required until the water-soluble detachment layer has been dissolved in step x) and the particle size of the precipitated transfer ply particles are dependent in particular on the temperature of the washing liquid, the friction occurring and the quantity of transfer product, preferably in the form of transfer product shreds, in the recycling container and/or in the washing liquid bath. The higher the temperature of the washing liquid and the higher the friction are, in particular the faster the dissolution of the water-soluble detachment layer is effected and the smaller the transfer ply particles are produced, wherein transfer ply particles which are too small, in particular nanoscale, can preferably be avoided.

Further, it is possible, through the choice of the corresponding geometry and the volume of the recycling container, in particular a container for the washing liquid bath, the fill level of the washing liquid, the quantity of transfer product, in particular in the form of transfer product shreds, per run and the recirculation in the washing process, to prevent the constituents of the carrier film and/or of the transfer ply from sticking together and/or folding together.

During step x) the washing liquid preferably has a temperature in a range of from 0° C. to 100° C., preferably in a range of from 15° C. to 50° C. In the range of from 15° C. to 50° C. it is possible to carry out the detachment of the transfer ply from the carrier film in a particularly energy-saving manner. A temperature of the washing liquid of for example 100° C. is also possible. It is hereby possible to minimize the time for detaching the transfer ply from the carrier film.

The washing liquid with the transfer product is preferably stirred during step x). The stirring duration lies in particular in a range of from 1 minute to 15 minutes, preferably from 3 minutes to 5 minutes. The stirring speed of a stirrer lies in particular in a range of from 1 revolution per minute to 1,000 revolutions per minute, preferably from 10 revolutions per minute to 250 revolutions per minute.

Further, it is possible for the following step to be carried out, in particular during and/or after step x):
x1) separating the carrier film, in particular the carrier film shreds, from the washing liquid.

Through step x1) the material of the carrier film is in particular separated from the washing liquid, from which the purity of the transfer product after step x) and optional further steps is preferably determined. After step x1) the transfer product is regarded in particular as the carrier film and/or the material of the carrier film, preferably substantially without transfer ply.

In particular, the process also comprises the following step, preferably during and/or after step x):
x2) separating the transfer ply, in particular the transfer ply constituents, from the washing liquid.

The transfer ply, in particular the transfer ply constituents, is preferably removed from the washing liquid in step x2) by means of at least one thermal and/or mechanical separating process, in particular filtration, centrifugation and/or distillation.

Further, it is possible for the separated transfer ply to be supplied to further separation processes, preferably chemical and/or mechanical separation processes, and/or a professional disposal.

Further, it is possible for the following step to be carried out, in particular during and/or after step x):
x3) separating the detachable detachment layer dissolved in the washing liquid from the washing liquid.

Preferably, the detachable detachment layer dissolved in the washing liquid is removed from the washing liquid in step x3) by means of at least one thermal separating process, in particular permeation and/or evaporation and/or distillation, and/or at least partially concentrated, in particular with the result that the cleaned washing liquid can be at least partially re-used as starting liquid for step x). After step x1) and/or after step x2) and/or after step x3) the washing liquid is preferably fed in again as starting liquid for step x). Alternatively or additionally, it is conceivable that the washing liquid is at least partially supplied to a disposal. Here, the washing liquid is advantageously particularly clean or particularly easy to clean in further steps.

By means of the separation steps a clean recovery of the starting liquid of the washing liquid and/or an unmixed recovery of the carrier film is in particular made possible.

Further, it is provided in particular that in step x) the at least one transfer ply is removed from the carrier film by means of friction. In addition to the dissolution of the water-soluble detachment layer, the transfer ply is thus preferably also removed from the carrier film by means of friction or the detachment of the transfer ply from the carrier film is supported by means of friction. By friction is meant here in particular rubbing, which takes effect between the carrier film, in particular in its entirety or as transfer product shreds, and the washing liquid and/or a wall and/or a sieve of the cleaning device and/or of the washing liquid bath and/or among the transfer product shreds. Here, it is conceivable in particular that the detachment force generated by the rubbing forces in step x) is smaller than the detachment force necessary for the detachment between transfer ply and carrier film in the transfer product before the process for recycling the transfer product, preferably before step x). This is possible in particular because the necessary force for detaching the transfer ply from the carrier ply is reduced during the dissolution of the water-soluble detachment layer. Thus, it is possible to reduce in particular the effect of mechanical forces which could cause the finest particles in the washing liquid.

Step x2) preferably takes place close in time to the dissolution of the water-soluble detachment layer in step x), in order that transfer ply constituents can be prevented from splitting up further after the detachment from the carrier film in particular due to mechanical forces. As a result, transfer product shreds, in particular carrier film shreds, that are as pure as possible are preferably obtained, i.e. the foreign material proportion or the proportion of the transfer ply constituents relative to the carrier material is as small as possible.

Further, it is possible, in particular in the case that the carrier film in its entirety is guided through the washing liquid, for the process to have the following step before step x):
step x11): unwinding the transfer product from a feed roll by means of a feed device. The unwound transfer product is here brought into contact in particular with the washing liquid by guiding the transfer product preferably into a washing liquid bath.

Further, it is possible for a roughening and/or kiss-cutting and/or scratching of the transfer ply to be carried out between step x11) and step x). As a result, the water-soluble detachment layer preferably has a larger contact surface for the washing liquid. The speed of the dissolution of the water-soluble detachment layer can thus be increased. Here, the transfer product is preferably guided over a roll equipped with mechanical tools, for example with pins, with the result that preferably punctiform damage of the transfer ply is generated. The transfer product, in particular also the carrier film, can even be pierced as long as the transfer product can still remain sufficiently mechanically stable and does not tear. Corresponding tools, in particular pins, can have a spacing of from 1 mm to 5 mm over the width of the transfer product.

In particular, the following step is carried out after step x11) and after step x):
x12) winding the carrier film onto a take-up roll. The carrier film is here guided in particular out of the washing liquid bath. It is preferably provided here that the water-soluble detachment layer in dissolved form and/or the transfer ply in undissolved form remain in the washing liquid during the winding of the carrier film.

Here, the separation of the carrier film in step x1) is simplified because the carrier film can be easily guided out of the washing liquid again by the winding.

The transfer product, in particular the carrier film, is preferably guided through the washing liquid, preferably between step x11) and step x12), at a speed of from 1 m/min to 100 m/min. In particular, the transfer product, preferably the carrier film, is brought into contact with the washing liquid and/or guided through the washing liquid bath for a duration in a range of from 10 s to 150 s, preferably between step x11) and step x12).

For example, it is possible to guide the transfer product, in particular the carrier film, through the washing liquid bath by means of one or more deflection rollers. It is hereby possible in particular to increase the residence time and to accelerate the dissolution of the water-soluble detachment layer.

During step x) the washing liquid preferably has a temperature in a range of from 0° C. to 100° C., preferably in a range of from 15° C. to 50° C. In the range of from 15° C. to 50° C. it is possible to carry out the detachment of the transfer ply from the carrier film in a particularly energy-saving manner. A temperature of the washing liquid of 100° C. is also conceivable. It is hereby possible to minimize the time for detaching the transfer ply from the carrier film.

Further, it is possible for the carrier film to be guided through a cleaning bath, after the carrier film has been guided out of the washing liquid bath. Here, the carrier film is preferably brought into contact with a cleaning liquid, which preferably contains one or more materials preferably selected from water or alternatively mixtures of water and methanol, ethanol, n-propanol, isopropanol or mixtures thereof, and/or acetone. Further, it is possible to add additives and/or surfactants, such as for example defoamers, to the cleaning liquid. In particular, the materials named for the starting liquid of the washing liquid can preferably be used as starting liquid of the cleaning liquid. The starting liquid used for the cleaning liquid and/or the cleaning liquid is preferably identical to that of the starting liquid of the washing liquid and/or the washing liquid. Through the cleaning bath, residues of the washing liquid, which contains both proportions of the dissolved water-soluble detachment layer and transfer ply particles and still wet the cleaned carrier film, can in particular preferably be removed. In particular, already precipitated transfer ply particles are preferably to be prevented from adhering to the cleaned transfer film. Before the winding onto the take-up roll, the carrier film is preferably guided out of the cleaning bath again.

It is also possible for the carrier film to be dried, after the carrier film has been guided out of the washing liquid bath and/or the cleaning bath. After the drying it is optionally possible to remove any loose residues of the transfer ply by means of a suction and/or bonding device.

The process is thus carried out in particular in a roll-to-roll process and/or steps x11), x) and x12) are carried out in an inline process. It is also possible in an embodiment example for the production process and/or the application process for the transfer product to be carried out in an inline process within the process for recycling the transfer product, in particular with steps x11, x) and x12).

Further, it is possible for the following step further to be performed before step x), in particular before step x11):
transporting a roll with the transfer product to the feed device.

After step x12) the transfer product, in particular the carrier film and/or the material of the carrier film, preferably has a purity in a range of from 60.0 wt.-% to 100.0 wt.-%, preferably from 95.0 wt.-% to 100.0 wt.-%, particularly preferably from 99.0 wt.-% to 100.0 wt.-%.

In particular, it is provided that the transfer product has a foreign material proportion before step x11) in the range of from 0 wt.-% to 5 wt.-%, preferably from 0 wt.-% to 1 wt.-%, and/or has a foreign material proportion after step x12) in the range of from 0 wt.-% to 1 wt.-%, preferably from 0 wt.-% to 0.1 wt.-%.

Further, it is possible for the transfer product to have a varnish residue proportion before step x11) in the range of from 0 wt.-% to 100 wt.-%, preferably from 10% to 100 wt.-%, particularly preferably from 50 wt.-% to 100 wt.-%, and/or to have a varnish residue proportion after step x12) in the range of from 0 wt.-% to 5 wt.-%, preferably from 0% to 1 wt.-%, particularly preferably of approximately 0 wt.-%.

It is also conceivable that a mechanical abrasion system and/or a brush roll system and/or a foam roll system and/or a spray nozzle system is additionally used to detach the transfer ply from the carrier film in step x) and/or between steps x11) and x12). It is hereby possible in particular to accelerate the detachment of the transfer ply. In particular, it is conceivable to put the washing liquid, preferably additionally, onto the side of the transfer product coated with the transfer plies by means of spray nozzles, in order to achieve an even quicker detachment.

Further, it is possible for the process to comprise the following step before step x):
a) shredding the transfer product, by means of a shredder or a shredding device, into transfer product shreds, in particular carrier film shreds, preferably wherein the transfer product is present wound onto a roll.

It is thus possible to put the transfer product into the washing liquid in the form of transfer product shreds. Advantageously, it is thereby made possible for the washing liquid to soak into the transfer product better via cut edges and broken edges.

The transfer product shreds, in particular when viewed perpendicular to a plane spanned by the transfer product shreds, preferably have in each case a surface area in a range of from 0.1 cm² to 10 cm².

It is preferably provided that the transfer product shreds, in particular carrier film shreds, have a mass after step a) and/or before step x) in the range of from 0.01 mg to 100 mg, preferably from 0.5 mg to 10 mg, particularly preferably from 1 mg to 5 mg. The mass of the transfer product shreds is important in particular for a removal of the transfer ply constituents in step c) by means of mechanical cleaning by machine and/or important for as complete as possible a drying of the transfer product shreds in step e).

In particular, it is provided that the shredding device or the shredder in step a) comprises at least one device or combinations of devices selected from: guillotine, shredder, cutting mill, hammer mill and/or mill.

In particular, it is provided that the transfer ply is at least partially transferred to a substrate to be decorated before step x), in particular before step a) and/or before step x11), and preferably during the application process, in particular transfer process and/or laminating process and/or in-mold decoration process, wherein a transfer product is provided as a by-product. It is preferably then a transfer product with a transfer ply in the form of a residual transfer ply.

It is possible for the transfer product to be collected, in particular unmixed, collected by means of collection vessels. The collected transfer product can be uncut or alternatively also cut and/or shredded and/or compressed and/or pressed. It is preferably possible for the transfer product to be collected by means of collection vessels, in particular by means of a rack and/or container and/or transport box and/or banded bales, before step x), in particular before step a) and after the application process, preferably transfer process and/or laminating process and/or in-mold decoration process.

Banded bales preferably denote pressed transfer products the volume of which is minimized by pressing. In order to hold the pressed transfer products together, it is preferably provided that they are wrapped in bands, with the result that a banded bale is provided.

By unmixed is preferably meant that as far as possible only one transfer product is wound and/or collected on each roll. Good material properties of the end product or of the compact product and/or of the extrusion product are thus ensured.

It is thus possible for the process further to comprise the following step before step a):
collecting the transfer product by means of a collection vessel, in particular by means of a rack and/or container and/or transport box and/or banded bales.

It is preferably provided that the following step is further performed before step x), in particular before step a):
transporting the transfer product, in particular the transfer product shreds, preferably carrier film shreds, by means of a feeder and/or by means of at least one transport container, in particular collection vessel and/or rack and/or container and/or transport box and/or banded bales and/or big bag, wherein the at least one transport container is filled with the transfer product shreds, in particular before step x).

By feeder is meant any transport vehicles and/or conveyor belts and/or pneumatic conveyors or the like.

It is also possible for the transfer product to be wound, in particular onto a film core, in the form of a roll before step x), in particular before step a) and/or before step x11), and after the application process, in particular transfer process and/or laminating process and/or in-mold decoration process. In a further embodiment, the transfer product is wound unmixed, in particular onto a film core. Alternatively, the winding in the form of a roll can also be effected without a film core, thus corelessly, and/or effected onto a film core which is removed from the film roll after the winding, with the result that the film roll is then present coreless. Such a removable film core can be for example part of a machine on which the transfer product is processed.

By film core is meant in particular a cardboard roll and/or a plastic roll and/or a machine part, onto which the transfer product is or has been wound. The film core can either remain in the film roll or be removed from the film roll again after the film roll has been wound.

It is thus possible for the following step to be performed before step a) and/or before the unwinding in step x11):
winding the transfer product, in particular onto a film core, with the result that a roll is provided.

Further, it is possible for the process to comprise the following step before step a) and/or before the unwinding in step x11):
transporting the roll to the feed device and/or transporting the roll and/or the collection vessel to the shredder or the shredding device by hand and/or by means of a feeder.

The collecting or winding, in particular the unmixed collecting and/or winding, of the transfer product guarantees that the foreign material proportion is small. In step a) it is in particular also conceivable that, instead of one transfer product, several transfer products of one type are processed, in particular shredded, at the same time.

In particular, it is provided that before step x), and in particular before step a), the transfer product has a foreign material proportion in the range of from 0 wt.-% to 5 wt.-%, preferably from 0 wt.-% to 1 wt.-%. Because the transfer products are sorted, in particular sorted in an unmixed way, before the actual recycling process, the downstream recycling process can be designed to be more efficient and the resultant compact products and/or extrusion products and/or plastic products have improved material properties.

Further, it is also preferably provided that before step x), and in particular before step a) and/or before step x11), the transfer product has a proportion of adhesive strips and/or splicing tapes in the range of from 0 wt.-% to 0.5 wt.-%, preferably from 0 wt.-% to 0.1 wt.-%.

During the shredding of the transfer product in step a), it is provided in particular that the wound transfer product is cut into film webs, wherein the roll with the transfer product is fixed in a V-shaped depression, in particular is fixed horizontally, and is then cut open to the film core in the longitudinal direction by means of a blade, in particular from above or from below or from the side, and the film core is removed, in particular if there is a film core. Here, the roll is preferably cut open in such a way that the blade cuts perpendicularly to a tangent of the lateral surface in the direction of the film core. In particular in the case of cutting from above, the advantage results that the roll is fixed by the V-shaped depression and no further counter bearings are needed to absorb the cutting pressure of the blade. It is preferably provided that this process step is performed by means of a guillotine.

As mentioned at the start, the film core preferably consists of a different material from the transfer product, which is why it is preferably provided that this film core, which acts as foreign material, is removed.

It is preferably also possible for the shredder and/or the shredding device to cut and/or chop and/or shred and/or tear the transfer product in step a).

In a possible embodiment, it is provided that the transfer ply is at least partially removed from the carrier film in step a), during the shredding of the transfer product, and thus a mixture of transfer product shreds and/or carrier film shreds and/or transfer ply constituents results.

It is possible for transfer product shreds which have both a carrier film and a transfer ply to result. In particular, the aim is to release as many transfer ply constituents from the carrier film as possible after several process steps, with the result that optimally pure carrier film shreds result. Carrier film shreds preferably denote shreds in which the transfer ply is completely removed and which consist of the material of the carrier film alone and/or in a high proportion, preferably more than 97%, preferably more than 99.9%, particularly preferably more than 99.97%.

In particular, it is provided that the transfer product shreds after step a) and/or before step x) have a varnish residue proportion in the range of from 0 wt.-% to 100 wt.-%, preferably from 10% to 100 wt.-%, particularly preferably from 50 wt.-% to 100 wt.-%. It is also possible for varnish residues to comprise varnish dusts.

The transfer product shreds after step a) and/or before step x) advantageously have a fine material proportion in the range of from 0 wt.-% to 20 wt.-%, preferably from 0 wt.-% to 5 wt.-%.

In particular, it is provided that the varnish residue proportion and/or the fine material proportion is reduced successively from process step to process step.

In an embodiment, it is provided that the following step is further performed before step x), in particular after step a):
step c): mechanically cleaning the transfer product shreds, in particular carrier film shreds, by machine, in particular without washing liquid, in order to remove foreign materials and/or at least some of the transfer ply constituents.

The mechanical cleaning by machine in step c) is advantageously effected by means of friction, wherein the transfer product shreds are present in the dry state and at least some of the transfer ply constituents are removed. In particular, some of the transfer ply constituents still adhering to the carrier film after step c) are then removed in step x).

Further, it is preferably possible for the transfer product shreds to have a varnish residue proportion after step c) and/or before step x) in the range of from 0 wt.-% to 100 wt.-%, preferably from 10 wt.-% to 100 wt.-%, particularly preferably from 50 wt.-% to 100 wt.-%.

Further, it is possible for the process to have the following step, in particular after step a) and/or after step c) and/or after step x):

b) compressing the transfer product shreds, in particular carrier film shreds, into a compact product or extruding the transfer product shreds, in particular carrier film shreds, into an extrusion product.

In particular, it is possible for the following step to be performed one or more times, in particular between step x) and step a), step b) and/or step c):
transporting the transfer product shreds, in particular carrier film shreds, by means of a feeder and/or by means of at least one transport container, in particular collection vessel and/or rack and/or container and/or transport box and/or banded bales and/or big bag, wherein the at least one transport container is filled with the transfer product shreds, in particular before step x), step c) and/or step b).

By big bag is meant a flexible bulk container, which preferably consists of plastic. The big bag preferably has handles and/or loops, with the result that the big bag can be transported or loaded by means of a crane and/or forklift truck.

In an embodiment variant, it is preferably provided that the compressing is effected in step b) by means of agglomerating, in particular by means of a plastics compactor or by means of a pellet press.

It is preferably possible for the transfer product shreds, in particular carrier film shreds, to be compacted and/or compressed during the compressing in step b) in order to provide a compact product with a higher bulk density, in particular wherein the bulk density of the compact product has a bulk density higher by a factor of 1 to 20, preferably by a factor of 5 to 20, than the bulk density of the transfer product shreds, in particular carrier film shreds.

The bulk density indicates the ratio of the mass of a bulk material to its bulk volume. The space requirement for storing the compact product can be reduced through a higher bulk density. This also has a positive effect on the transport, as a larger mass can be transported with a constant volume. Further, the bulk density also has an influence on the process parameters of shaping processes, such as for example the injection molding and/or the extruding.

It is also provided that the following step is further performed before the extruding in step b):
shredding and/or mixing and/or heating and/or drying and/or degassing and/or compressing and/or buffering the transfer product shreds, in particular carrier film shreds, in a cutter compactor, in particular in order to increase the bulk density.

In particular during the degassing, for example, foreign substances can be removed, which are then filtered out through a filter system.

It is advantageously provided that the transfer product shreds, in particular carrier film shreds, are plasticized and homogenized during the extruding in step b) by means of an extruder system, in particular in order to produce an extrusion product and/or granular material. It is in particular provided that the transfer product shreds are heated up to their melting temperature by means of heat input and are then compressed by means of the extruder system, with the result that a uniform molten plastic is provided.

By extruder system is meant here in particular a single screw extruder, a co-rotating or counter-rotating twin screw extruder, a ring extruder, a planetary roller extruder, a multi-rotation system, a plasticator or another extruder system.

It is advantageously provided that the transfer product shreds, in particular carrier film shreds, are plasticized during the compressing in step b) by means of an extruder system, in particular in order to produce a compact product, which consists of compacted transfer product shreds.

It is advantageously also provided that the following step is further performed after the compressing or extruding in step b):
Liquid State Polymerization and/or Solid State Polymerization to improve the material properties, in particular to increase the molecular weight and/or to increase the viscosity.

It is preferably possible for the melting temperature of the transfer product shreds, in particular carrier film shreds, to lie in a range of from 100° C. to 350° C., in particular from 150° C. to 320° C., preferably from 260° C. to 290° C., in step b) during the extruding.

It is preferably possible for the melting temperature during the extruding of the transfer product shreds, in particular carrier film shreds, preferably if the carrier film comprises PET as main constituent, to lie in a range of from 150° C. to 320° C., preferably from 260° C. to 290° C., in step b).

It is preferably possible for the temperature during the compressing of the transfer product shreds, in particular carrier film shreds, to lie in a range of from 25° C. to 150° C., preferably from 40° C. to 120° C., in step b).

In particular, it is provided that a vacuum and/or negative pressure which preferably lies in a range of from 0.01 mbar to 1,013 mbar is generated in the extruder system in step b).

After step b) the compact product and/or extrusion product advantageously has a purity in the range of from 60.0 wt.-% to 100.0 wt.-%, preferably from 95.0 wt.-% to 100.0 wt.-%, particularly preferably from 99.0 wt.-% to 100.0 wt.-%. As already mentioned further above, the purity is advantageously improved successively from step to step.

In particular, it is provided that the compact product and/or extrusion product has an intrinsic viscosity in the range of from 0.3 dl/g to 0.9 dl/g, preferably from 0.5 dl/g to 0.7 dl/g, after step b).

It is preferably also possible for the compact product and/or extrusion product to be colorless, transparent, crystal clear, opaque, dyed, at least partially dyed or colored after step b). In particular in the case of a colorless and/or transparent and/or crystal clear compact product and/or extrusion product, there is the advantage that it can afterwards be dyed as desired.

After step b) the compact product and/or extrusion product is advantageously formed cylindrical and has a cylinder diameter in the range of from 0.1 mm to 20 mm, preferably from 3 mm to 10 mm, particularly preferably from 4 mm to 6 mm, and a cylinder height in the range of from 0.1 mm to 20 mm, preferably from 3 mm to 10 mm, particularly preferably from 4 mm to 6 mm. After step b) the compact product and/or extrusion product can preferably also be spherical and have a diameter in the range of from 0.1 mm to 20 mm, preferably in the range of from 3 mm to 10 mm, particularly preferably in the range of from 4 mm to 6 mm.

In particular, it is possible for the carrier film or the material of the carrier film after step x), and the compact product and/or extrusion product, in particular after step b), to be suitable for at least one subsequent process or a combination of processes selected from: injection molding, extrusion, pressing processes, compounding, chemical recycling and/or energy recovery.

In particular, it is provided that the following step is further performed after step x), in particular after step a) and/or after step b):
step f): compounding the compact product and/or the extrusion product, wherein additives are added in order to provide a compound with improved material properties.

It is preferably provided that a compound is provided as molten material and/or as granular material after the compounding.

It is advantageously possible for the transfer product shreds and/or the compact product and/or extrusion product together with the additives to be conveyed and/or plasticized and/or homogenized in step f) in a compounder, in particular an extruder system, for example a single screw extruder, a co-rotating or counter-rotating twin screw extruder, a ring extruder, a planetary roller extruder, a multi-rotation system, a plasticator and/or another extruder system.

It is preferably provided that the following step is further performed before step f), in particular after step b):
transporting the compact product and/or the extrusion product and/or the transfer product shreds, in particular carrier film shreds, by means of a feeder and/or by means of at least one transport container, in particular collection vessel and/or rack and/or container and/or transport box and/or banded bales and/or big bag, wherein the at least one transport container is filled with the compact product and/or the extrusion product and/or the transfer product shreds, in particular before step f).

In step f) the molten compound is advantageously further processed directly in a shaping process, in particular an injection-molding process and/or pressing process and/or extrusion process. This has the advantage that the compound does not have to be further processed into a granular material first, before it is ultimately finally processed into a molded plastic part and/or extrusion product in further processing processes, preferably in an injection-molding process and/or pressing process and/or extrusion process. Transport and storage are thus dispensed with. Further, the advantage results that the energy consumption can be lowered, as the compound is already present in the molten state and thus no longer needs to be additionally melted and/or plasticized and/or homogenized for the injection-molding process and/or pressing process and/or extrusion process.

It is preferably provided that the melting temperature for the compound lies in a range of from 100° C. to 350° C., in particular from 150° C. to 320° C., preferably from 260° C. to 290° C., in step f) when the shaping process is being carried out.

It is preferably provided that the melting temperature for the compound, in particular if the carrier film comprises PET as main constituent, lies in a range of from 150° C. to 320° C., preferably from 260° C. to 290° C., in step f) when the shaping process is being carried out.

In particular, it is also provided that the molten compound is further processed into a granular material in step f) by means of strand granulation and/or underwater granulation. After this process step a high-quality granular plastic material with good material properties is advantageously obtained, which can subsequently be used as raw material in an injection-molding process and/or pressing process and/or extrusion process.

It is preferably also provided that the melting temperature lies in a range of from 100° C. to 350° C., in particular from 150° C. to 320° C., preferably from 260° C. to 290° C., in step f) during the compounding.

It is preferably also provided that the melting temperature, in particular if the carrier film comprises PET as main constituent, lies in a range of from 150° C. to 320° C., preferably from 260° C. to 290° C., in step f) during the compounding.

Further, it is also preferably provided that a vacuum and/or negative pressure which preferably lies in a range of from 0.01 mbar to 1,013 mbar is generated in the compounder, in particular extruder system, in step f) during the compounding.

The compound and/or granular material, in particular in the case of PET as main constituent, advantageously has a notch toughness after step f), in particular measured according to Charpy at room temperature, in the range of from 1 kJ/m² to 100 kJ/m², preferably from 5 kJ/m² to 60 kJ/m².

Further, it is preferably provided that the compound and/or granular material, in particular in the case of PET as main constituent, has a modulus of elasticity (E modulus) after step f), in particular determined at room temperature by means of a tensile test, in the range of from 1,000 MPa to 10,000 MPa, preferably from 1,300 MPa to 8,000 MPa.

It is possible in particular for the compound and/or granular material to have a purity after step f) in the range of from 20.0 wt.-% to 99.9 wt.-%, preferably from 50 wt.-% to 99.9 wt.-%, particularly preferably from 80 wt.-% to 99.9 wt.-%.

It is possible in particular for the transfer product, in particular the carrier film in its entirety or as carrier film shreds, to have a residual moisture after step x), wherein among other things constituents of the washing liquid also adhere to the carrier film. The residual moisture and also the constituents of the washing liquid need to be removed before possible further steps, in particular the rolling up onto a take-up roll in step x12), the compressing and/or extruding and/or compounding. For this purpose, a drying step is advantageously effected after the dissolution of the water-soluble detachment layer in step x). It is thus possible for the following step further to be performed after step x), in particular before step x12) and/or before step b):
step e) drying the transfer product, in particular the carrier film in its entirety or as carrier film shreds, preferably by means of a mechanical dehydration and/or a mechanical dryer and/or thermal dryer, in particular in order to reduce the moisture of the transfer product.

It is provided in particular that the following step is further performed before step e):
transporting the transfer product shreds, in particular carrier film shreds, by means of a feeder and/or by means of at least one transport container, in particular collection vessel and/or rack and/or container and/or transport box and/or banded bales and/or big bag, wherein the at least one transport container is filled with the transfer product shreds, in particular before step e).

If the transfer product, in particular the carrier film in its entirety, is wound onto a take-up roll, it is possible for a drying portion in front of the take-up roll preferably to be passed through by the transfer product, in particular the carrier film, to carry out the drying in step e).

It is preferably possible for the thermal dryer to have a temperature in the range of from 10° C. to 120° C., preferably from 40° C. to 80° C., in step e).

In particular, it is provided that the transfer product, in particular the transfer product shreds and/or the carrier film in its entirety, have a moisture after step e) in the range of from 0% to 25%, preferably from 0% to 5%, particularly preferably in the range of from 0% to 1%.

Preferably, the transfer product, in particular the transfer product shreds, preferably the carrier film shreds and/or the carrier film in its entirety, has a purity after step e) in the range of from 60.0 wt.-% to 100.0 wt.-%, preferably from 95.0 wt.-% to 100.0 wt.-%, particularly preferably from 99.0 wt.-% to 100.0 wt.-%. As already described previously, the degree of purity is improved successively from step to step.

It is further preferably provided that the transfer product and/or the transfer product shreds are colorless, transparent, crystal clear, opaque, dyed, at least partially dyed or colored after step e).

Further, it is possible for the transfer product, in particular the carrier film, preferably in the form of carrier film shreds or in its entirety, to be cleaned again with a cleaning liquid after step x) and preferably before step e). The cleaning liquid preferably comprises or consists of one or more substances selected from water or alternatively mixtures of water with one or more further substances. In particular, one or more alcohols, preferably selected from methanol, ethanol, n-propanol, isopropanol or mixtures thereof, and/or acetone are used as one or more further substances.

Further, it is possible to add additives and/or surfactants, such as for example defoamers, to the cleaning liquid. In particular, it is possible, if the cleaning liquid comprises substances which would in particular at least partially start to dissolve the transfer ply, for the cleaning to be carried out after step x1).

The process according to the invention is suitable in particular for recycling transfer products the transfer plies of which consist of different materials from the carrier film.

Such a process offers the advantage that used transfer products are not thrown away, but are reprocessed, with the result that further life cycles result. The transfer product according to the invention and/or the transfer product used in the process according to the invention is preferably produced and constructed according to the “Design for Recycling (DfR)” principle. This offers substantial economic and ecological advantages as the production of new plastics can be dispensed with. Through the successive removal of the transfer ply, plastic material that is as pure as possible is obtained, which can be used to produce new carrier film and/or other plastic components.

Further embodiments of the invention are represented in the figures and described below. There are shown in:

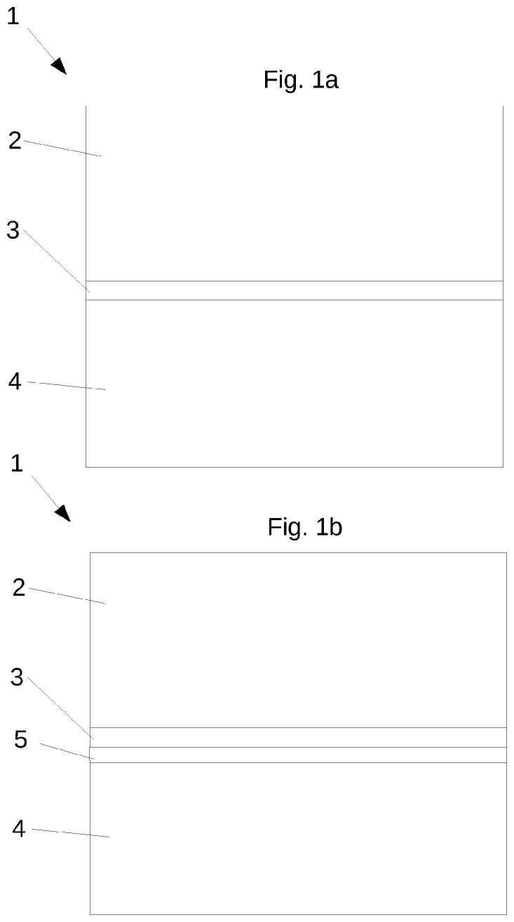

FIGS. 1a, 1b, 2, 3: schematic sectional representations of a section of a transfer film

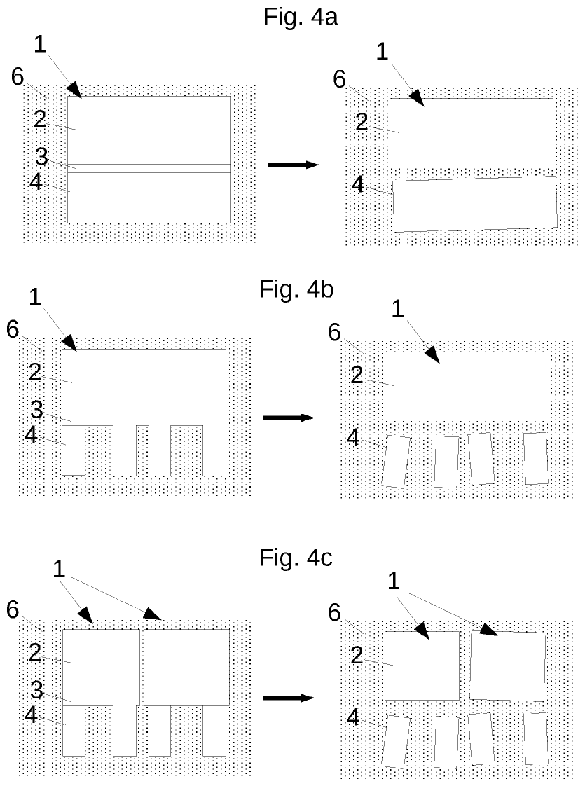

FIGS. 4a, 4b, 4c: schematic representations of a recycling process for a transfer product

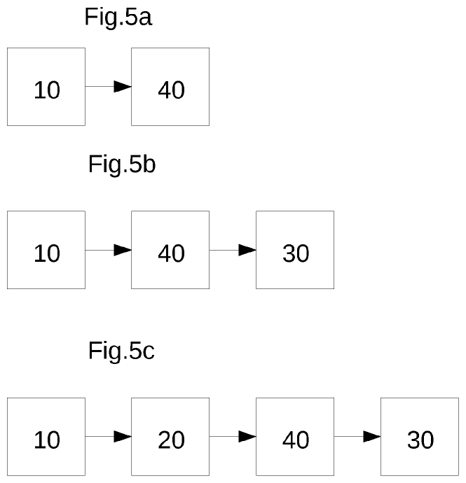

FIGS. 5a, 5b, 5c: schematic representations of a recycling process for a transfer product

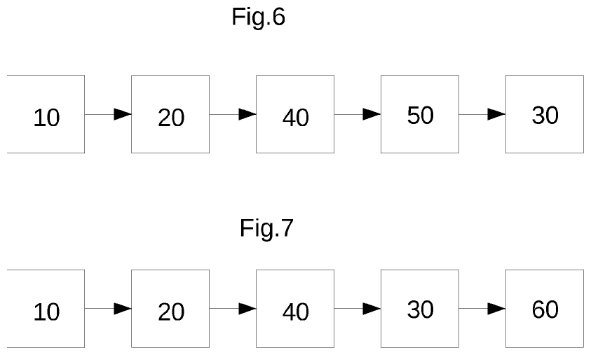

FIG. 6 to FIG. 11: schematic representations of a recycling process for a transfer product

In the following, the invention is explained by way of example with reference to several embodiment examples utilizing the attached drawings. The embodiment examples shown are therefore not to be understood as limitative. FIG. 1a shows a transfer product 1. The transfer product 1 is in particular a recyclable transfer product, preferably a transfer product which is recyclable in water. The transfer product 1 contains the non-water-soluble carrier film 2 and the non-water-soluble transfer ply 4. The non-water-soluble transfer ply 4 is arranged on the carrier film 2 at least partially, here for example over the whole surface. The water-soluble detachment layer 3 is arranged between the carrier film 2 and the transfer ply 4.

It is thus possible in particular here for a ply arranged on the carrier film 2, such as for example the transfer ply 4, to denote a ply which is not in direct contact with the carrier film 2, but is joined to the carrier film 2 via one or more further layers, such as for example via at least the water-soluble detachment layer 3.

The transfer product 1 is preferably a hot-stamping film, a cold-stamping film and/or a thermotransfer film.

The water-soluble detachment layer 3 preferably has a layer thickness in a range of from 0.01 μm to 1 μm, preferably in the range of from 0.05 μm to 0.3 μm, here for example 0.15 μm. The water-soluble detachment layer 3 contains in particular one or more water-soluble compounds, preferably one or more polymers and/or oligomers, preferably selected from polyvinyl alcohol, polyvinyl pyrrolidone, carboxymethyl cellulose, methyl cellulose, polyols, starch, saccharides, gum arabic, gelatin, lipids, polyethylene oxide, polyvinyl butyral, polyester, polyurethane, polyacrylic acid, polyamide or a combination thereof. The detachment layer 3 contains for example polyvinyl alcohol, which is or was produced from partially saponified polyvinyl acetate with degrees of saponification in a range of from 75% to 100%.

Further, it is possible for further water-soluble and/or non-water-soluble detachment layers to be arranged between the carrier film 2 and the transfer ply 4.

The carrier film 2 is preferably produced by means of extrusion, in particular flat film extrusion. The layer thickness of the carrier film 2 preferably lies in a range of from 3 μm to 100 μm, preferably in a range of from 4.5 μm to 12 μm, here for example at 6 μm. It is possible for the carrier film to be colorless, transparent, crystal clear, opaque, dyed, at least partially dyed or colored.

The carrier film 2 consists in particular of or comprises in particular polyester. The carrier film 2 preferably comprises or consists of one or more components or composite materials selected from polyethylene terephthalate (PET), polylactide, polyethylene furanoate, polybutylene terephthalate, polytrimethylene terephthalate, polyethylene naphthalate, and/or from polyethylene, polypropylene, polycarbonate, polyester carbonate, cellophane, cellulose acetate, polyvinyl chloride, polystyrene, polyamide, polyimide, polyvinylidene chloride and/or paper, in particular coated and/or laminated paper.

The carrier film has for example a main constituent, preferably PET. The proportion of this main constituent, preferably the PET, in the carrier film 2 is preferably more than 97%, preferably more than 99.9%, particularly preferably more than 99.97%.

Further, it is possible for the transfer ply 4 to have at least one layer or a combination of layers, preferably in the following order starting from the side of the transfer ply facing the water-soluble detachment layer, selected from: non-water-soluble detachment layer, protective varnish layer, metal layer, color layer, adhesive layer, primer layer, adhesion-promoting layer.

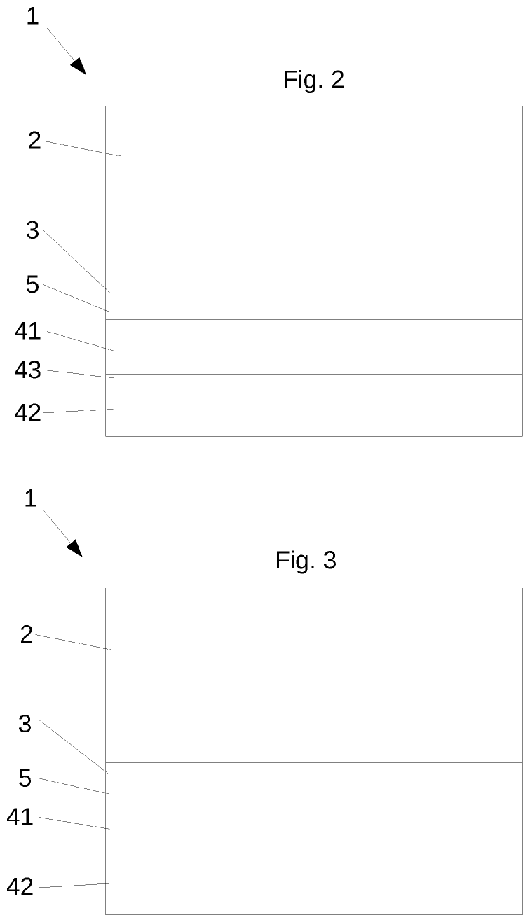

The protective varnish layer has in particular a layer thickness in a range of from 0.5 μm to 15 μm, in particular from 0.8 μm to 2 μm, preferably for a transfer product 1 in which a metal layer is present, as is shown for example in FIG. 2. The protective varnish layer further preferably has a layer thickness of from 0.8 μm to 10 μm, preferably for a transfer product 1 in which no metal layer is present, as is shown for example in FIG. 3.

The protective varnish layer 41 preferably contains one or more binders selected from nitrocellulose, polyurethanes, polyacrylates and copolymers thereof, polymethacrylates and copolymers thereof, polyester resins, styrene resins, maleic acid anhydride-based resins, hydrocarbon resins, shellac, alkyd resins, colophony resins, maleic resins, melamine resins, formaldehyde resins, ethylene-vinyl acetate copolymers, polybutyral, polyamides, plasticizers or a combination of two or more of these components and/or dyes and/or organic and/or inorganic pigments and/or matting agents. The protective varnish layer is preferably crystal clear colorless.

Further, it is possible for the protective varnish layer to be dyed with soluble dyes and/or organic and/or inorganic color pigments and/or provided with matting agents. In combination with a subsequent metal layer, as is shown by way of example in FIG. 2, a metallic gloss effect is generated in particular. In the case of non-metallized transfer products, as such a transfer product 1 is shown by way of example in FIG. 3, pigments are preferably used in order to be able to achieve in particular an intense covering power of the transfer ply relative to the substrate surface.

The metal layer has in particular a layer thickness in a range of from 5 nm to 50 nm, preferably from 10 nm to 15 nm, here for example 13 nm. The metal layer preferably comprises or consists of aluminum, chromium, silver, gold, copper, nickel, tin, indium or alloys of at least two of these metals. Alternatively or additionally, it is possible for the metal layer to contain or to consist of one or more compounds, preferably with high refractive indices, selected from silicon oxide, magnesium oxide, titanium oxide, aluminum oxide, zinc oxide or zinc sulfide.

The primer layer has in particular a layer thickness in a range of from 0.1 μm to 5 μm. Here, it is possible for the transfer product 1 to be a cold-stamping film and preferably to have a layer thickness in a range of from 0.1 μm to 0.5 μm. Further, it is possible for the primer layer to have a layer thickness in a range of from 0.5 μm to 3 μm, in particular in the case where the transfer product 1 is a hot-stamping film. The primer layer makes it possible in particular for a sufficient adhesion of the transfer ply to the substrate, in particular in the application process, to be able to be produced.

A non-water-soluble detachment layer, which is additionally depicted by way of example as the layer 5 in FIG. 1b, is preferably arranged between the non-water-soluble transfer ply 4 and the water-soluble detachment layer 3. The detachment layers 3 and 5 are mono- or multilayer.

In particular, it is possible for the non-water-soluble detachment layer 5 or a further detachment layer to be at least partially transferable with the transfer ply 4. In other words, it is possible for the non-water-soluble detachment layer 5, if it is not a reject, to be or to have been transferred to a substrate with the transfer ply 4 in an application process.

The non-water-soluble detachment layer 5 has in particular a layer thickness in a range of from 0.01 μm to 0.5 μm, preferably in the range of from 0.01 μm to 0.2 μm, here for example of 0.15 μm.

The non-water-soluble detachment layer 5 is preferably produced from a wax based on one or more of the following components: polyethylene, polypropylene, fats, fatty acids and derivatives thereof, lipids, long-chain alcohols, one or more fluorinated compounds, in particular polytetrafluoroethylene, polyvinylidene fluoride and/or fluorinated fatty acids, modified and/or unmodified silicone waxes and/or resins.

In particular, the non-water-soluble detachment layer improves the transfer of the transfer ply to a substrate surface in an application process, for example in a transfer process and/or laminating process and/or insert-molding process and/or in-mold decoration process, because the detachment force for detaching the transfer ply from the carrier film is preferably set thereby.

The non-water-soluble detachment layer preferably is not or has not been produced on an aqueous basis and/or in particular has no aqueous dispersion. As a result, it is also guaranteed in particular that the washing liquid 6 merely forms a homogeneous solution with the water-soluble detachment layer 3.

FIG. 2 shows the transfer product 1 described in FIG. 1b, wherein the transfer ply 4 has a protective varnish layer 41 on its side facing the water-soluble detachment layer 3. The protective varnish layer here has a layer thickness of for example 1 μm. The protective varnish layer consists in particular of nitrocellulose, polyurethanes, polyacrylates and copolymers thereof, polymethacrylates and copolymers thereof, polyester resins, styrene resins, maleic acid anhydride-based resins, hydrocarbon resins, shellac, alkyd resins, colophony resins, maleic resins, melamine resins, formaldehyde resins, ethylene-vinyl acetate copolymers, polybutyral, polyamides, plasticizers or a combination of two or more of these components and/or dyes and/or organic and/or inorganic pigments and/or matting agents.

A metal layer 43 is arranged on the side of the protective varnish layer 41 facing away from the water-soluble detachment layer 3. A primer layer 42 is arranged on the side of the metal layer 43 facing away from the protective varnish layer 41. The metal layer 43 here has for example a layer thickness of 13 nm and the primer layer 42 has a layer thickness of for example 1 μm.

FIG. 3 shows the transfer product 1 described in FIG. 1b, wherein the transfer ply 4 has a protective varnish layer 41 on its side facing the water-soluble detachment layer 3.

In particular, the transfer product 1 shown in FIG. 3 preferably does not have a metal layer. The protective varnish layer 41 preferably has a layer thickness in a range of from 0.8 μm to 10 μm, for example 5 μm. The primer layer has for example a layer thickness of 1 μm.

Here, it is also possible for the primer layer 42 to be joined to the protective varnish layer 41, in particular by means of an adhesion-promoter layer not represented here. The adhesion-promoter layer preferably comprises or consists of one or more of the following materials: polyurethanes, polyesters, polyamides, polycarbonates, polyureas, polyacrylates and/or copolymers thereof, polymethacrylates and/or copolymers thereof, hydrocarbon resins, shellac, alkyd resins, colophony resins, ketone resins, phenolic resins, polystyrene resins, epoxy resins, maleic resins, melamine resins, formaldehyde resins, polyvinyl acetates, ethylene-vinyl acetate copolymers, polyvinyl chloride, nitrocellulose, polyolefins, modified polyolefins and/or plasticizers.

With respect to the further structure and the functions of the films, layers and plies shown in FIG. 2 and FIG. 3, reference is made in particular to the above statements. Further, it is possible for the transfer ply shown in FIG. 2 and in FIG. 3 to be used as a transfer ply of the transfer product shown in FIG. 1a.

In particular, it is possible for the transfer ply, in particular in the form of transfer ply constituents, to have a layer structure of the transfer ply described in FIGS. 1a, 1b, 2 and 3 in the process for recycling the transfer product. Further, it is possible for the carrier film, in particular in the form of carrier film shreds or as an entire carrier film, to have the layer structure of the carrier film described in FIGS. 1a, 1b, 2 and 3 in the process for recycling the transfer product.

Further, it is possible for the carrier film 2 and/or the transfer ply 4 and/or the non-water-soluble detachment layer 5 to have one or more layers which are porous at least in areas and/or water-permeable at least in areas, in particular such that the transfer product can be passed through by the washing liquid from at least one outer surface, which is preferably not formed by the water-soluble detachment layer, up to the water-soluble detachment layer.

Advantageously, step x), thus in particular the dissolution of the water-soluble detachment layer by means of the washing liquid, is hereby accelerated, as a larger surface of the water-soluble detachment layer can be brought into contact with the washing liquid. If for example the non-water-soluble detachment layer 5 shown in FIG. 1b is water-impermeable and/or porous, the washing liquid can in particular come into contact with the horizontally depicted surface of the water-soluble detachment layer 3 through the outer surfaces, depicted on the right and left, of the non-water-soluble detachment layer 5, in particular if the depicted part of the transfer product is regarded as transfer product shreds.

The detachment force for detaching the transfer ply 4 from the carrier film 2 here is preferably influenced by the design of the water-soluble detachment layer 3 and optionally the non-water-soluble detachment layer 5 described in relation to FIG. 1b. In particular, the detachment force for detaching the transfer ply 4 from the carrier film 2 is for example 2 cN/cm. The smallest detachment force within or between two or more layers of the transfer ply 4 is present for example within the primer layer 42 and is larger than the detachment force for detaching the transfer ply 4 from the carrier film 2 and is in particular for example 3 cN/cm to 5 cN/cm here. It is thus guaranteed in particular that, when the carrier film 2 is detached from the transfer ply 4 in an application process, the primer layer 42 is not divided and that the transfer ply 4 can form for example sharp edges on the substrate, which make optically ambitious effects possible.

The transfer product 1 described in relation to FIG. 1a, FIG. 1b, FIG. 2 and FIG. 3 is in particular supplied to and/or used in the process for recycling a transfer product.

FIG. 4a shows an example process for recycling a transfer product 1 having a non-water-soluble carrier film 2 and a non-water-soluble transfer ply 4 arranged at least partially on the carrier film 2. A water-soluble detachment layer 3 is arranged between the carrier film 2 and the transfer ply 4 of the transfer product 1. To recycle the transfer product 1, the following step is carried out:
step x): dissolving 40 the water-soluble detachment layer 3 by means of a washing liquid 6. Here, the transfer ply 4 is detached from the carrier film 2. The washing liquid 6 is preferably located in a washing liquid bath and in particular the transfer product 1 is put into the washing liquid bath.

In particular, the carrier film 2 is cleaned by means of the washing liquid 6 during step x). For this purpose, the transfer product 1 is in particular released from the transfer ply 4, with the result that the carrier film 2 preferably substantially remains as transfer product 1 after step x). It is preferably possible for the transfer product 1, in particular the carrier film 2 and/or the material of the carrier film, to have a purity after step x) in the range of from 60.0 wt.-% to 100.0 wt.-%, preferably from 95.0 wt.-% to 100.0 wt.-%, particularly preferably from 99.0 wt.-% to 100.0 wt.-%. The transfer product 1 after step x) preferably has a varnish residue proportion in the range of from 0 wt.-% to 5 wt.-%, preferably from 0% to 1 wt.-%, particularly preferably of approximately 0 wt.-%. Further, it is possible for the transfer product to have a fine material proportion after step x) in the range of from 0 wt.-% to 5 wt.-%, preferably from 0 wt.-% to 1 wt.-%, particularly preferably of approximately 0 wt.-%.

Between reaching the purity and step x), still further process steps, such as for example a drying of the carrier film 2 or the carrier film shreds after step x), can in particular also be carried out.

With a carrier film 2 as shown by way of example in FIGS. 4a and 4b, it is possible in particular for the carrier film 2 in its entirety to be guided through the washing liquid 6. It is possible for the transfer ply 4 to be present likewise in its entirety on the carrier film 2, for example if the transfer product 1 represents rejects, or for the transfer ply 4 to be present in the form of transfer ply constituents on the carrier film 2. The transfer ply constituents are for example the residual transfer ply, which has remained on the carrier ply 2 after a partial transfer of the transfer ply 4 to a substrate, and/or the transfer ply constituents were separated from each other for example before step x) in a shredding step. With a transfer product 1 as shown in FIG. 4c, it is possible for transfer product shreds comprising carrier film shreds and transfer ply constituents to be put into the washing liquid 6. By the carrier film 2 is therefore preferably meant both the carrier film 2 in its entirety and a number of carrier film shreds. By the transfer ply 4 is preferably meant both the transfer ply 4 in its entirety and a number of transfer ply constituents.

Preferably before step x) the transfer product 1 has in particular a structure which is described in relation to FIG. 1a, FIG. 1b, FIG. 2 and FIG. 3. Further, it is possible for in particular the transfer ply 4 detached during or after step x), preferably the detached transfer ply constituents in each case, to have a layer sequence which is described in relation to the transfer ply 4 in one of FIG. 1a, FIG. 1b, FIG. 2 and FIG. 3.

In step x) the washing liquid 6 soaks into the transfer product 1 for example via cut edges and/or broken edges and/or diffuses through non-water-soluble transfer ply layers and begins to dissolve the water-soluble detachment layer 3 on contact with it.

As can be seen in FIG. 4b and in FIG. 4c, it is possible for the transfer ply 4 not to be present in areas in which the water-soluble detachment layer 3 is present. Here, it is possible for the non-water-soluble detachment layer 5 also to be present there. Here, the carrier film 2 with the water-soluble detachment layer 3 and in particular the optional non-water-soluble detachment layer 5 was detached from the transfer ply 4 in these areas for example in a preceding application process for transferring the transfer ply 4 to a substrate. Further, it is possible for the water-soluble detachment layer 3 and in particular the optional non-water-soluble detachment layer 5 to have been transferred to a substrate or target object with the transfer ply 4 in a preceding application process, with the result that the water-soluble detachment layer 3 and in particular the optional non-water-soluble detachment layer 5 is not present in the areas without transfer ply 4 before step x). Detachment layers transferred to a substrate with the transfer ply 4 preferably have a high level of transparency, in particular a transmittance of from 95% to 100%, preferably in a wavelength range of from 350 nm to 800 nm.

During step x) the washing liquid 6 is in particular formed of a homogeneous solution of a starting liquid and the water-soluble detachment layer 3. In particular, the washing liquid 6 thus corresponds substantially to the starting liquid which receives the dissolved water-soluble detachment layer 3 during step x). Water or a homogeneous mixture of water with one or more further substances is preferably used as starting liquid for the washing liquid 6, in particular before step x). In particular, one or more alcohols, preferably selected from methanol, ethanol, n-propanol, isopropanol or mixtures thereof, and/or acetone are used as one or more further substances. Further, it is possible to add additives and/or surfactants, such as for example defoamers, to the washing liquid 6. If the washing liquid 6 and/or its starting liquid is water, this water preferably does not have any further additives and/or is untreated water. The composition of the washing liquid 4 is preferably to be selected depending on the transfer product 1, in particular the transfer ply 4, in particular such that the transfer ply 4 is not dissolved by the washing liquid. The transfer ply 4 preferably does not have a layer dissolvable in the washing liquid 6 in particular in the case of the recycling process.

The transfer ply 4 detached from the carrier film 2 in step x) is hereby preferably present, in particular after step x), in the form of transfer ply constituents in the washing liquid 6. The transfer ply constituents are present in particular in undissolved form in the washing liquid 6 and/or the transfer ply constituents in the washing liquid 6 cohesively have the entire layer structure of the transfer ply 4 of the transfer product 1. In other words, it is possible for the layer structure of the carrier film 2 and/or of the transfer ply 4 of the transfer product 1 to be preserved during step x), as the transfer ply 4 is insoluble in the washing liquid 6.

The transfer ply constituents in the washing liquid 6 advantageously have a particle size in a range of from 10 μm to 5 mm, preferably in a range of from 20 μm to 5 mm, particularly preferably in a range of from 50 μm to 5 mm. By the particle size is meant here in particular the maximum distance between two points of a particle.

An optional separation of the transfer ply 4, in particular of the transfer ply constituents, into smaller constituents, which for example form smaller transfer ply particles, and/or of the carrier film 2, in particular into smaller carrier film particles, would be conceivable, in particular through mechanical forces, before, during and/or after step x). In particular, such mechanical forces are exerted in a targeted manner in shredding steps or also unintentionally in other steps. It is also conceivable for example that further foreign substances are present in the washing liquid 6, for example through abrasion of components. In particular, 99 wt.-% to 100 wt.-% of particles undissolved in the washing liquid 6, in particular comprising foreign substances, the smaller carrier film particles, the smaller transfer ply particles and the transfer ply constituents, advantageously have a particle size in a range of from 10 μm to 5 mm, preferably in a range of from 20 μm to 5 mm.

The washing liquid 6 with the particles undissolved therein, in particular from the transfer product, is advantageously present as a preferably compact and stable suspension, in particular with particles with the above-named particle sizes. Here, finest particles, which would require expensive separation steps, which for example an expensive filtration, are not present in the washing liquid 6 or preferably only to a very small extent. As a result, fine particles are in particular prevented from sticking to the carrier film 2 and thus the purity of the recyclate or the effort for achieving a particular purity is improved. Further, in particular the recoverability of the washing liquid 6, the maintenance and repair effort and the process reliability is improved. The water-soluble detachment layer 3 advantageously makes this possible in that no or only particularly small mechanical forces, which could cause a separation of very fine particles, are used in particular to separate the transfer ply 4 from the carrier film 2 in step x).

It is expedient that during and/or after step x) the washing liquid 6 with the transfer product 1 consists of the carrier ply 2 and the transfer ply 4 with a concentration in a range of from 0.1 wt.-% to 25 wt.-%, preferably 1 wt.-% to 10 wt.-%. The concentration is calculated in particular from the ratio of the sum of the weight of carrier ply 2 and transfer ply 4 present in the washing liquid 6 to the weight of the washing liquid 6 with the water-soluble detachment layer 3 dissolved in the washing liquid 6, with the carrier film 2 and with the transfer ply 4. It is thus preferably substantially the solids concentration in the washing liquid 6 with the transfer product 1.

Preferably, step x) is carried out by means of at least one cleaning device or a combination of cleaning devices selected from: stirred tank, washer, hot washer, friction washer, wet cutting device, and/or wet cutting mill. For example, it is possible for the at least one transfer ply 4 to be removed from the carrier film 2 through the dissolution of the water-soluble detachment layer 3 and in particular by means of friction in step x).

The time required until the water-soluble detachment layer 3 has been dissolved in step x) and the particle size of the precipitated transfer ply particles are dependent in particular on the temperature of the washing liquid 6, the friction and the quantity of transfer product 1, preferably in the form of transfer product shreds, in a recycling container and/or in the washing liquid bath. The higher the temperature of the washing liquid 6 and the higher the friction are, in particular the faster the dissolution of the water-soluble detachment layer 3 is effected and the smaller the transfer ply particles are produced, wherein transfer ply particles which are too small, in particular nanoscale, can be avoided. Further, it is possible, through the choice of the corresponding geometry and the volume of the recycling container, in particular a container for the washing liquid bath, the fill level of the washing liquid 6, the quantity of transfer product 1, in particular in the form of transfer product shreds, per run and the friction, to prevent the constituents of the carrier film 2 and/or of the transfer ply 4 from sticking together and/or folding together.

During step x) the washing liquid 6 preferably has a temperature in a range of from 0° C. to 100° C., preferably in a range of from 15° C. to 50° C. In the range of from 15° C. to 50° C., it is possible to carry out the detachment of the transfer ply 4 from the carrier film 2 in a particularly energy-saving manner. A temperature of the washing liquid 6 of 100° C. is also conceivable. It is hereby possible to minimize the time for detaching the transfer ply 4 from the carrier film 2.

Further, it is possible for the following step to be carried out, in particular during and/or after step x) with the dissolution 40 of the water-soluble detachment layer 3:
step x1): separating the carrier film 2, in particular the carrier film shreds or the carrier film in its entirety, from the washing liquid 6.

Through step x1), in particular the material of the carrier film is separated from the washing liquid, from which the purity of the transfer product after step x) and optional further steps is preferably determined. Further, the process preferably comprises the following step, preferably during and/or after step x) with the dissolution of the water-soluble detachment layer 3:
step x2): separating the transfer ply 4, in particular the transfer ply constituents, from the washing liquid 6.

The transfer ply 4, in particular the transfer ply constituents, is preferably removed from the washing liquid 6 in step x2) by means of at least one thermal and/or mechanical separating process, in particular filtration, centrifugation and/or distillation. It is possible for step x2) to be carried out before step x1). Further, it is possible for the separated transfer ply to be supplied to further separation processes, preferably chemical separation processes, and/or a professional disposal.

Further, it is possible for the following step to be carried out, in particular during and/or after step x):
step x3): separating the detachable detachment layer 3 dissolved in the washing liquid 6 from the washing liquid 6.

Preferably, the detachable detachment layer 3 dissolved in the washing liquid is removed from the washing liquid 6 in step x3) by means of at least one thermal separating process, in particular permeation and/or evaporation and/or distillation, and/or at least partially concentrated, in particular with the result that the cleaned washing liquid 6 can be at least partially re-used as starting liquid for step x).

After step x1) and/or after step x3), the washing liquid 6 is preferably fed in again as starting liquid for step x). Alternatively or additionally, it is conceivable that the washing liquid 6 is supplied at least partially to a disposal.

By means of the separation steps, a clean recovery of the starting liquid of the washing liquid, a clean disposal of the washing liquid and/or an unmixed recovery of the carrier film is in particular made possible.

It is preferably provided that after the dissolution 40 of the water-soluble detachment layer 3, in particular after step x), the transfer product, in particular the transfer product shreds and/or the carrier film in its entirety, has a purity in the range of from 60.0 wt.-% to 100.0 wt.-%, preferably from 95.0 wt.-% to 100.0 wt.-%, particularly preferably from 99.0 wt.-% to 100.0 wt.-%.

It is preferred that before the dissolution of the water-soluble detachment layer 3 in step x) and after an application process, in particular a transfer process and/or laminating process and/or in-mold decoration process, the transfer product 1 is wound, in particular onto a film core, in the form of a roll. In particular, it is also provided that before the dissolution 40 of the water-soluble detachment layer 3 in step x) and after the application process the transfer product 1 is collected by means of collection vessels, in particular by means of a rack and/or container and/or transport box and/or banded bales.

In a further embodiment, it is provided that the transfer product 1 is wound unmixed, in particular onto a film core, in the form of a roll, in particular before step x). Alternatively, the winding in the form of a roll can also be done without a film core, thus corelessly, and/or effected onto a film core which is removed from the film roll after the winding, with the result that the film roll is then present coreless. Such a removable film core can be for example part of a machine on which the transfer product 1 is processed.

It is also provided that the transfer product 1 can be collected unmixed. Unmixed means that only transfer products which are of the same and/or similar nature, for example have the same carrier material, are wound or collected on the roll. It is thus ensured that no further foreign bodies and/or foreign materials flow into the recycling process. This additionally increases the quality and improves the material properties of the end product and/or compact product and/or extrusion product.

It is also provided that before the dissolution 40 of the water-soluble detachment layer 3 and during the application process the transfer ply 4 is at least partially transferred to a substrate to be decorated, wherein a transfer product 1 is provided as a by-product.

In particular, the following step is further performed before the dissolution 40 of the water-soluble detachment layer 3: winding the transfer product, in particular onto a film core, with the result that a roll is provided. In particular, this process step is performed after the production of rejects. Rejects denotes transfer products in the production of which errors have occurred, for example a layer of the transfer ply may not have been deposited with sufficient quality. Such rejects are not provided for sale to customers. In order to keep the resulting damage as small as possible, the transfer product declared to be a reject is recycled, in order that the materials can be re-used.

The collecting or winding, in particular the unmixed collecting and/or winding, of the transfer product 1 guarantees that the foreign material proportion is small. In particular, it is provided that before step x), in particular before step a), the transfer product 1 has a foreign material proportion in the range of from 0 wt.-% to 5 wt.-%, preferably from 0 wt.-% to 1 wt.-%. Because the transfer products are sorted, in particular sorted in an unmixed way, before the actual recycling process, the downstream recycling process can be designed to be more efficient and the recyclate, in particular the resultant compact products and/or extrusion products and/or plastic products, have improved material properties.

Further, it is also preferably provided that before step x), in particular before step a), the transfer product has a proportion of adhesive strips and/or splicing tapes in the range of from 0 wt.-% to 0.5 wt.-%, preferably from 0 wt.-% to 0.1 wt.-%.

FIG. 5a shows an example process for recycling a transfer product 1 with the dissolution 40 of the water-soluble detachment layer 3 in step x) and the following step, which is carried out in particular before the dissolution 40 of the water-soluble detachment layer 3:
step a): shredding 10 the transfer product 1, by means of a shredder or a shredding device, into transfer product shreds, in particular carrier film shreds, preferably wherein the transfer product is present wound onto a roll.

It is hereby possible to put the transfer product 1 into the washing liquid 6 in the form of transfer product shreds. It is advantageously thereby made possible for the washing liquid 6 to soak into the transfer product better via cut edges and broken edges. A section of a transfer product 1 which has been shredded into transfer product shreds is described for example in relation to FIG. 4c.

The transfer product shreds, in particular when viewed perpendicular to a plane spanned by the transfer product shreds, preferably have in each case a surface area in a range of from 0.1 cm² to 10 cm². The surface would be visible for example when the transfer product 1 shown in FIG. 4c is viewed top down. As a result, it is in particular also guaranteed that, if the layer thickness of the transfer ply 4 is for example smaller than 50 μm, the transfer ply particles are large enough.

Further, it is preferably provided that the following step is further performed before the shredding 10, in particular in step a):
transporting the roll to the shredder or the shredding device by hand and/or by means of a feeder.

It can also be provided that during the shredding 10 of the transfer product 1, in particular in step a), the wound transfer product is cut into film webs, wherein the roll with the transfer product 1 is fixed in a V-shaped depression, in particular is fixed horizontally, and is then cut open to the film core in the longitudinal direction by means of a blade, in particular from above or from below or from the side, and the film core is removed, in particular if there is a film core. This has the advantage that the transfer product is easily detached from the film core quickly and can be used for further processing.

In particular, it is possible for the shredder and/or the shredding device to cut and/or chop and/or shred and/or tear the transfer product during the shredding 10, in particular in step a).

It is further preferably provided that the transfer ply 4 is at least partially removed from the carrier film 2 during the shredding 10 of the transfer product, in particular in step a), and thus a mixture of transfer product shreds and/or carrier film shreds and/or transfer ply constituents results.

Advantageously, the transfer product shreds have a varnish residue proportion in the range of from 0 wt.-% to 100 wt.-%, preferably from 10% to 100 wt.-%, particularly preferably from 50 wt.-% to 100 wt.-%, after the shredding 10, in particular in step a), and preferably before the dissolution 40 of the water-soluble detachment layer 3.

It is advantageously provided that the transfer product shreds have a fine material proportion in the range of from 0 wt.-% to 20 wt.-%, preferably from 0 wt.-% to 5 wt.-%, after the shredding 10, in particular in step a), and preferably before the dissolution 40 of the water-soluble detachment layer 3.

It is also preferably possible for the transfer product shreds, in particular carrier film shreds, to have a mass in the range of from 0.01 mg to 100 mg, preferably from 0.5 mg to 10 mg, particularly preferably from 1 mg to 5 mg, after the shredding 10, in particular in step a).

FIG. 5b shows the process shown in FIG. 5a, except that the following step is further carried out after the dissolution 40 of the water-soluble detachment layer 3 in step x), in particular after step x1):
step b): compressing 30 the transfer product shreds, in particular carrier film shreds, into a compact product.

The compressing 30 is preferably effected by means of agglomerating, in particular by means of a plastics compactor or by means of a pellet press.

It is preferably also provided that an extruding 31 of the transfer product shreds, in particular the carrier film shreds, into an extrusion product is effected in step b).

FIG. 5c shows a process as described in relation to FIG. 5a or FIG. 5b. In the embodiment shown in FIG. 5c, it is preferably provided that the following step is further performed after the shredding 10 of step a) and in particular before the dissolution 40 of the washing liquid 6 of step x):
step c): mechanically cleaning 20 the transfer product shreds, in particular carrier film shreds, by machine, in particular without washing liquid, in order to remove foreign materials and/or at least some of the transfer ply constituents.

During the mechanical cleaning 20 of the transfer product shreds by machine, in particular in step c), foreign materials and/or transfer ply constituents are advantageously removed. The mechanical cleaning 20 by machine is preferably effected after the shredding 10, in order to separate transfer ply constituents separated from the carrier film and/or the transfer ply during the shredding, in particular residues of the transfer ply, such as for example varnish residues, varnish dusts and/or fine material, from the transfer product shreds.

In particular, it is provided that the mechanical cleaning 20 by machine, in particular in step c), is effected by means of friction, wherein the transfer product shreds are present in the dry state and at least some of the transfer ply constituents are removed. The rest of the transfer ply constituents are in particular removed from the carrier film, and thus in particular from the transfer product, in step x), thus the dissolution 40 of the water-soluble detachment layer 3.

The transfer product shreds advantageously have a varnish residue proportion in the range of from 0 wt.-% to 100 wt.-%, preferably from 10 wt.-% to 100 wt.-%, particularly preferably from 50 wt.-% to 100 wt.-%, after the mechanical cleaning 20 by machine, in particular after step c) and in particular before the dissolution 40 of the water-soluble detachment layer 3 of step x).

It is preferably possible for the following step further to be performed before the compressing 30:
transporting the transfer product shreds, in particular carrier film shreds, by means of a feeder and/or by means of at least one transport container, in particular collection vessel and/or rack and/or container and/or transport box and/or banded bales and/or big bag, wherein the at least one transport container is filled with the transfer product shreds, in particular with carrier film shreds, in particular before the compressing 30, preferably after step x1).

Further, it is provided in particular that the transfer product shreds, in particular carrier film shreds, are compacted and/or compressed during the compressing 30, in particular in step b), in order to provide a compact product with a higher bulk density, in particular wherein the bulk density of the compact product has a bulk density higher by a factor of 1 to 20, preferably by a factor of 5 to 20, than the bulk density of the transfer product shreds, in particular carrier film shreds.

A further process for recycling a transfer product is represented in FIG. 6. This process includes the steps presented in FIG. 5a, FIG. 5b and FIG. 5c of shredding 10, mechanical cleaning 20 by machine, compressing 30 and dissolution 40 of the water-soluble detachment layer 3, wherein a drying 50 takes place after the dissolution 40 of the water-soluble detachment layer 3. The drying 50 takes place in particular also before the compressing 30.

In particular in order to reduce the moisture of the transfer product shreds after the dissolution 40 of the water-soluble detachment layer 3, in particular after step x), it is preferably provided to perform the following step:
drying 50 the transfer product 1, in particular the carrier film 2 in its entirety or as carrier film shreds, preferably by means of a mechanical dehydration and/or a mechanical dryer and/or thermal dryer, in particular in order to reduce the moisture of the carrier film, for example as transfer product shreds.

Advantageously, it is possible for the transfer product shreds to have a moisture in the range of from 0% to 25%, preferably from 0% to 5%, after the drying 50, in particular after step e). Through the drying 50, it is guaranteed in particular that no further substances which are contained in the washing liquid 6 also flow into the subsequent process step.

In addition to the following process step of compressing 30 shown in particular in FIG. 5b, FIG. 5c and FIG. 6, it is preferably also possible for an extruding 31 to be performed. In particular during the compressing 30 and/or extruding 31, it is of particular importance that the transfer product shreds to be compressed and/or to be extruded have a high degree of purity. In general it is true that the purer the material to be compressed and/or extruded is, the better the material properties of the compact product and/or extrusion product are after the compressing 30 and/or extruding 31. By material properties is meant properties and physical and chemical properties, for example the density, the melting temperature, the strength, the notch toughness, the modulus of elasticity, the shear modulus and/or the viscosity. Therefore, it is provided in particular that the transfer product shreds have a purity in the range of from 60.0 wt.-% to 100.0 wt.-%, preferably from 95.0 wt.-% to 100.0 wt.-%, particularly preferably from 99.0 wt.-% to 100.0 wt.-%, after the drying 50, in particular in step e).

A further schematic representation of a recycling process for a transfer product is represented in FIG. 7. This recycling process likewise comprises the steps of shredding 10, mechanically cleaning 20 by machine, compressing 30 and dissolving 40 the water-soluble detachment layer 3 already presented in FIG. 5c and FIG. 6.

Instead of the compressing 30, an extruding 31 can also be effected. However, a compounding 60 also takes place after the compressing 30 or extruding 31. It is preferably provided that a compact product and/or extrusion product and/or transfer product shreds is compounded, wherein additives are added in order to provide a compound with improved material properties. In particular, this is the case for the generation of rejects during the production process for the transfer product. In the case of such rejects, the carrier film of the transfer product is preferably almost completely covered with a transfer ply. If this is the case, the danger exists in particular that proportions of the transfer ply cannot be sufficiently removed. It is thus possible for the transfer product shreds, in particular in this case, to be compressed with a high proportion of transfer ply, which is deemed to be foreign material. Due to the high foreign material proportion, the plastic is not pure and therefore does not have optimal material properties. In particular through the addition of additives during the compounding 60, the material properties can be improved, with the result that the plastic is suitable for further processing, for example injection molding and/or pressing and/or extruding.

In particular, it is provided that during the compounding 60, preferably in step f), the compact product and/or extrusion product and/or transfer product shreds together with the additives is conveyed and/or plasticized and/or homogenized in a compounder, in particular an extruder system, for example a single screw extruder, a co-rotating or counter-rotating twin screw extruder, a ring extruder, a planetary roller extruder, a multi-rotation system, a plasticator and/or another extruder system.

The granular material obtained during the compounding 60 in the extruder system can then preferably be further processed in further process steps into a further carrier film and/or other plastic products, for example by means of injection molding and/or pressing processes and/or extrusion.

Alternatively, the compounding 60 can in particular also be effected in an inline process. Here, it is possible for the molten compound to be further processed preferably directly in a shaping process, in particular an injection-molding process and/or pressing process and/or extrusion process.

During the compounding 60, the melting temperature lies for example in a range of from 100° C. to 350° C., in particular from 150° C. to 320° C., preferably from 260° C. to 290° C. In particular if the carrier film 2 comprises PET as main constituent, the melting temperature preferably lies in a range of from 150° C. to 320° C., preferably from 260° C. to 290° C., during the compounding 60.

Further, it is possible for the melting temperature for the compound to lie in a range of from 100° C. to 350° C., in particular from 150° C. to 320° C., preferably from 260° C. to 290° C., in step f) when the shaping process is being carried out. In particular if the carrier film 2 comprises PET as main constituent, it is possible for the melting temperature for the compound to lie in a range of from 150° C. to 320° C., preferably from 260° C. to 290° C., for example to be 275° C., in step f) when the shaping process is being carried out.

A vacuum and/or negative pressure which preferably lies in a range of from 0.01 mbar to 1,013 mbar is preferably generated in the compounder, in particular extruder system, during the compounding 60.

The compound and/or granular material after the compounding 60, in particular in step f), in particular if the carrier film 2 comprises PET as main constituent, preferably has a notch toughness, in particular measured according to Charpy at room temperature, in the range of from 1 kJ/m² to 100 kJ/m², preferably from 5 kJ/m² to 60 kJ/m².

The compound and/or granular material after the compounding 60, in particular in step f), in particular if the carrier film comprises PET as main constituent, further preferably has a modulus of elasticity (E modulus), in particular determined at room temperature by means of a tensile test, in the range of from 1,000 MPa to 10,000 MPa, preferably from 1,300 MPa to 8,000 MPa.

It is preferably also provided that the compound and/or granular material after the compounding 60, in particular after step f), has a purity in the range of from 20.0 wt.-% to 99.9 wt.-%, preferably from 50.0 wt.-% to 99.9 wt.-%, particularly preferably from 80.0 wt.-% to 99.9 wt.-%.

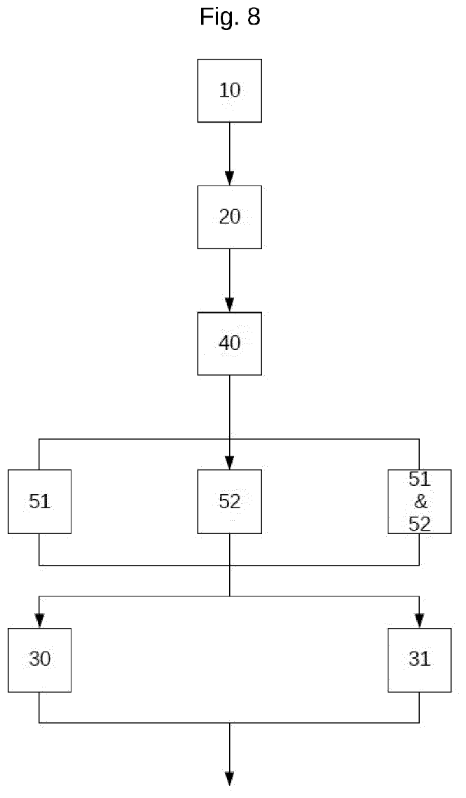

FIG. 8 shows a further schematic representation of a recycling process for a transfer product, wherein several possibilities are illustrated here for how such a process can be composed. Such a recycling process, as shown in FIG. 8, is used in particular if the transfer ply of the transfer product has previously been transferred to a substrate to be decorated using an application process, in particular transfer process and/or laminating process and/or in-mold decoration process. Through this recycling process, plastic that is as clean or pure as possible, which can serve for example as a basis for a new carrier film and/or other plastic products, is preferably recovered.

Preferably, as shown in particular in FIG. 5a, FIG. 5b, FIG. 5c and FIG. 6, a shredding 10 is effected first, in particular followed by a mechanical cleaning 20 by machine. After the mechanical cleaning 20 by machine, a cleaning 40 of the transfer product shreds with washing liquid by dissolution of the water-soluble detachment layer 3 by means of at least one cleaning device or combinations of cleaning devices selected from: washer, hot washer, friction washer, wet cutting device, and/or wet cutting mill, is in particular provided. In this embodiment example, it is also preferably provided that the washing liquid 6 comprises water or a homogeneous mixture of water with one or more further substances. In particular, one or more alcohols, preferably selected from methanol, ethanol, n-propanol, isopropanol or mixtures thereof, and/or acetone are used as one or more further substances. Further, it is possible to add additives and/or surfactants, such as for example defoamers, to the washing liquid 6. The transfer ply 4 is hereby at least partially removed from the carrier film and transfer ply constituents undissolved in the washing liquid 6 result.

In order to extract the moisture resulting from the dissolution 40 of the detachment layer 3 with the washing liquid 6 from the transfer product shreds, in particular the carrier film shreds, a drying by means of a mechanical dryer 51 and/or drying by means of a thermal dryer 52 is in particular provided. Other drying processes can preferably also be used. It is provided in particular that the drying steps are carried out as often as desired and/or in any desired order. Thus, for example, a drying with a combination of a mechanical dryer 51 and a thermal dryer 52 is also possible.

Further, it is possible for the carrier film 2, in particular in the form of carrier film shreds, to be cleaned again with a cleaning liquid after step x), preferably after step x1), and preferably before the drying 50. The cleaning liquid preferably comprises or consists of one or more substances selected from water or alternatively a homogeneous mixture of water with one or more further substances. In particular, one or more alcohols, preferably selected from methanol, ethanol, n-propanol, isopropanol or mixtures thereof, and/or acetone are used as one or more further substances. Further, it is possible to add additives and/or surfactants, such as for example defoamers, to the washing liquid. In particular, it is possible, if the cleaning liquid comprises substances which would in particular at least partially dissolve the transfer ply 4, for the cleaning to be carried out after step x1).

A compressing 30, preferably by means of a plastics compactor, and/or an extruding 31 of the transfer product shreds, in particular carrier film shreds, preferably by means of an extruder system, into an extrusion product is preferably effected after the drying 50 of the transfer product shreds.

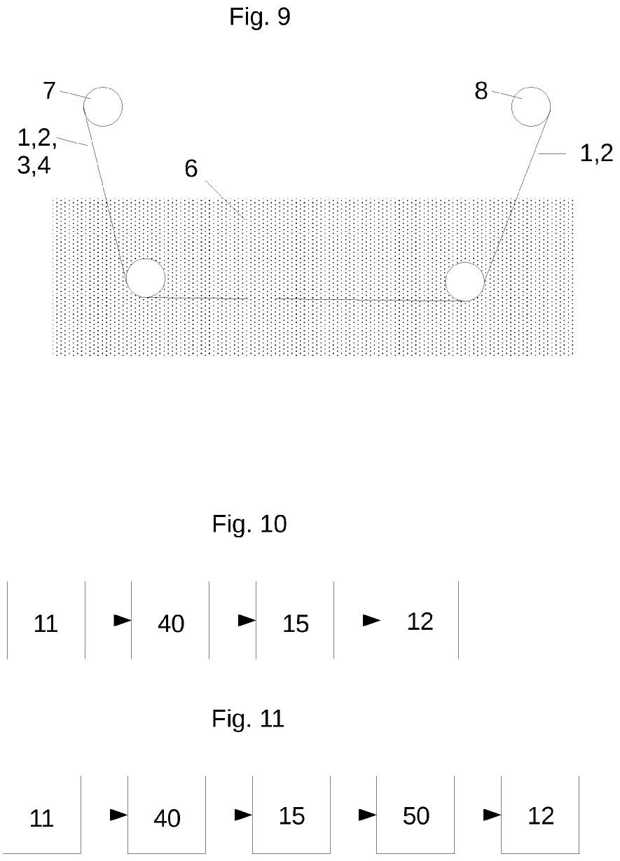

FIG. 9 shows an example process which has the following step before the dissolution 40 of the water-soluble detachment layer 3 of step x):
step x11): unwinding 11 the transfer product 1 from a feed roll 7 by means of a feed device. Here, the unwound transfer product 1 is brought into contact with the washing liquid 6. In particular, the transfer product 1 is guided into the washing liquid bath for this purpose, for example by means of one or more deflection rollers.

Preferably, the process further has the following step after step x11) and after step x):
step x12) winding 12 the carrier film 2 onto a take-up roll 8, in particular wherein the carrier film 2 is guided out of the washing liquid bath.

The water-soluble detachment layer 3 in dissolved form and/or the transfer ply 4 in undissolved form preferably remains in the washing liquid 6 in step x12). Accordingly, in particular only the carrier film 2 is rolled onto the take-up roll 8. Here, in particular, the separation of the carrier film 2 in step x1) is made easier because the carrier film 2 can be easily pulled out of the washing liquid 6 again preferably by the winding 12.

The transfer product 1, in particular the carrier film 2, is preferably guided through the washing liquid, preferably between step x11) and step x12), at a speed of from 1 m/s to 100 m/s. In particular, the transfer product 1, in particular the carrier film 2, is preferably brought into contact with the washing liquid 6 and/or guided through the washing liquid bath for a duration in a range of from 10 s to 150 s between step x11) and step x12).

In particular, it is possible to increase the residence time by means of the one or more deflection rollers and/or to accelerate the dissolution of the water-soluble detachment layer 3, for example because of the friction between transfer ply 4 and washing liquid 6 and/or between the water-soluble detachment layer 3 and the washing liquid 6.

Further, it is possible for the carrier film 2 to be guided through a cleaning bath, after the carrier film 2 has been guided out of the washing liquid bath. Here, the carrier film 2 is preferably brought into contact with a cleaning liquid, which preferably contains one or more materials selected from water or alternatively a homogeneous mixture of water with one or more further substances. In particular, one or more alcohols, preferably selected from methanol, ethanol, n-propanol, isopropanol or mixtures thereof, and/or acetone are used as one or more further substances. Further, it is possible to add additives and/or surfactants, such as for example defoamers, to the washing liquid. Before the winding 12 onto the take-up roll 8, the carrier film 2 is preferably guided out of the cleaning bath again.

It is also possible for the carrier film 2 to be dried after the carrier film 2 has been guided out of the washing liquid bath and/or the cleaning bath.

The process is thus carried out in particular in a roll-to-roll process and/or steps x11), x) and x12) are carried out in an inline process. An embodiment example is also conceivable in which the production process and/or the application process for the transfer product are carried out in an inline process in the process for recycling the transfer product, in particular with steps x11, x) and x12).

It is also conceivable that, to detach the transfer ply 4 from the carrier film 2 in step x) and/or between steps x11) and x12), a mechanical abrasion system and/or a brush roll system and/or a foam roll system and/or a spray nozzle system is additionally used, wherein spray nozzles bring the washing liquid onto the transfer ply preferably in a targeted manner. As a result, it is possible in particular to accelerate the detachment.

The transfer product 1, in particular the carrier film 2 and/or the material of the carrier film, preferably has a purity in a range of from 60.0 wt.-% to 100.0 wt.-%, preferably from 95.0 wt.-% to 100.0 wt.-%, particularly preferably from 99.0 wt.-% to 100.0 wt.-%, after step x12).

In particular, it is provided that the transfer product 1 has a foreign material proportion before step x11) in the range of from 0 wt.-% to 5 wt.-%, preferably from 0 wt.-% to 1 wt.-%, and/or has a foreign material proportion after step x12) in the range of from 0 wt.-% to 1 wt.-%, preferably from 0 wt.-% to 0.1 wt.-%.

Further, it is possible for the transfer product 1 to have a varnish residue proportion before step x11) in the range of from 0 wt.-% to 100 wt.-%, preferably from 10% to 100 wt.-%, particularly preferably from 50 wt.-% to 100 wt.-%, and/or to have a varnish residue proportion after step x12) in the range of from 0 wt.-% to 5 wt.-%, preferably from 0% to 1 wt.-%, particularly preferably of approximately 0 wt.-%.

Further, it is possible for the transfer product 1 to have a fine material proportion in the range of from 0 wt.-% to 1 wt.-%, preferably of approximately 0 wt.-%, after step x12).

FIG. 10 shows the process described by way of example in relation to FIG. 9 with the steps in the specified order: unwinding 11 the transfer product and in particular inserting the transfer product 1 in the washing liquid 6, dissolving 40 the water-soluble detachment layer, guiding 15 the carrier film out of the washing liquid 6, rolling up 12 the carrier film. The separation of the carrier film 2 from the washing liquid 6 is carried out here in particular at least partially by the guiding 15 of the carrier film 2 out of the washing liquid 6.

It is also possible for the following step further to be performed before step x), in particular before step x11):
transporting a roll with the transfer product 1 to the feed device. The roll is preferably used as feed roll 7 and has been wound for example during or after a preceding application process or represents rejects of a production process for the transfer product.

FIG. 11 shows the recycling process described by way of example in relation to FIG. 10, wherein a drying 50 of the carrier film 2 takes place before the rolling-up 12 of the carrier film 2. The drying 50 is preferably carried out by means of a mechanical dryer and/or thermal dryer.

Further, in particular, a separation of the transfer ply 2 from the washing liquid 6 takes place after the dissolution 40 of the water-soluble detachment layer 3, with the result that the transfer ply 2 can here also be further processed in subsequent processes, such as in particular mechanical and/or chemical separation processes. In particular, it is possible for the transfer ply 2 to be removed from the washing liquid 6 in step x2) by means of at least one thermal and/or mechanical separating process, in particular filtration, centrifugation and/or distillation and then preferably to be supplied to further separation processes, preferably chemical separation processes, and/or to a professional disposal. In addition, it is possible for the water-soluble detachment layer 3 dissolved in the washing liquid 6 to be separated from the washing liquid 6 and in particular re-used in step x) and/or supplied to a professional disposal. As there are preferably no or only very small proportions of the carrier film 2 in the washing liquid 6, corresponding processes are made easier.

Between the dissolution 40 of the water-soluble detachment layer 3 and the drying 50, in a preferred embodiment another cleaning is provided, in particular wherein the transfer product 1, preferably the carrier film 2, is guided out of the washing liquid bath, is guided into a cleaning bath with a cleaning liquid as described above and is guided out of the cleaning bath before the drying 50. After the drying, it is optionally possible to remove any loose residues of the transfer ply, in particular by means of a suction and/or bonding device.

### LIST OF REFERENCE NUMBERS

1 transfer product
2 carrier film
3 water-soluble detachment layer
4 transfer ply
5 non-water-soluble detachment layer
41 protective varnish layer
42 primer layer
43 metal layer
6 washing liquid
7 feed roll
8 take-up roll
10 shredding
11 unwinding the transfer product
12 winding the transfer product
20 mechanical cleaning by machine
30 compressing
31 extruding
40 dissolving the water-soluble detachment layer
50 drying
51 drying by means of a mechanical dryer
52 drying by means of a thermal dryer
60 compounding
61 compounding and processing in an offline process
62 compounding and processing in an inline process

1. A transfer product, having a non-water-soluble carrier film and a non-water-soluble transfer ply arranged at least partially on the carrier film, wherein a water-soluble detachment layer is arranged between the carrier film and the transfer ply.

2. The transfer product according to claim 1, wherein
the water-soluble detachment layer has a layer thickness in a range of from 0.01 μm to 1 μm.

3. The transfer product according to claim 1, wherein
the water-soluble detachment layer contains one or more water-soluble compounds.

4. The transfer product according to claim 1, wherein
a non-water-soluble detachment layer is arranged between the transfer ply and the water-soluble detachment layer.

5. The transfer product according to claim 1, wherein
the non-water-soluble detachment layer has a layer thickness in a range of from 0.01 μm to 0.5 μm.

6. The transfer product according to claim 1, wherein
the non-water-soluble detachment layer is produced from a wax.

7-10. (canceled)

11. The transfer product according to claim 1, wherein
the transfer ply has at least one layer or a combination of layers, selected from: non-water-soluble detachment layer, protective varnish layer, metal layer, color layer, adhesive layer, primer layer, adhesion-promoting layer.

12. The transfer product according to claim 1, wherein the transfer ply has a
protective varnish layer with a layer thickness in a range of from 0.5 μm to 15 μm.

13. (canceled)

14. The transfer product according to claim 1, wherein the transfer ply has a
the metal layer with a layer thickness in a range of from 5 nm to 50 nm.

15. (canceled)

16. The transfer product according to claim 1, wherein the transfer ply has a
primer layer with a layer thickness in a range of from 0.1 μm to 5 μm.

17. (canceled)

18. The transfer product according to claim 1, wherein
the carrier film and/or the transfer ply and/or the non-water-soluble detachment layer has one or more layers which are porous at least in areas and/or water-permeable at least in areas.

19. The transfer product according to claim 1, wherein a
detachment force for detaching the transfer ply from the carrier film lies in a range of from 1 cN/cm to 10 cN.

20. The transfer product according to claim 1, wherein a
smallest detachment force within or between two or more layers of the transfer ply is at least twice as large as a force for detaching the transfer ply from the carrier film.

21. A process for recycling a transfer product having a non-water-soluble carrier film and a non-water-soluble transfer ply arranged at least partially on the carrier film, wherein a water-soluble detachment layer is arranged between the carrier film and the transfer ply and wherein the following step is carried out in the process:
x) dissolving the water-soluble detachment layer by means of a washing liquid, wherein the transfer ply is detached from the carrier film.

22. (canceled)

23. The process according to claim 21, wherein
during step x) the washing liquid is formed of a homogeneous solution of a starting liquid and the water-soluble detachment layer.

24. The process according to claim 21, wherein
water or a homogeneous mixture of water with one or more further substances is used as starting liquid for the washing liquid.

25. The process according to claim 21, wherein
the transfer ply detached from the carrier film in step x) is present in the form of transfer ply constituents in the washing liquid.

26. The process according to claim 21, wherein the transfer ply constituents are present in undissolved form in the washing liquid and/or wherein the transfer ply constituents in the washing liquid cohesively have the entire layer structure of the transfer ply.

27. The process according to claim 21, wherein
the transfer ply constituents in the washing liquid have a particle size in a range of from 10 μm to 5 mm, preferably in a range of from 20 μm to 5 mm.

28. The process according to claim 21, wherein
during and/or after step x) the washing liquid with the transfer product consists of the carrier ply and the transfer ply with a concentration in a range of from 0.1 wt. % to 25 wt. %.

29. The process according to claim 21, wherein
the washing liquid has a temperature in a range of from 0° C. to 100° C. during step x).

30. The process according to claim 21, wherein
the washing liquid with the transfer product is stirred during step x).

31. The process according to claim 21, wherein the washing liquid with the transfer product is stirred during step x) for a stirring duration in a range of from 1 minute to 15 minutes.

32. The process according to claim 21, wherein
the washing liquid with the transfer product is stirred during step x) at a stirring speed of a stirrer in a range of from 1 revolution per minute to 1,000 revolutions per minute.

33. The process according to claim 21, wherein
step x) is carried out by means of at least one cleaning device or a combination of cleaning devices selected from: stirred tank, washer, hot washer, friction washer, wet cutting device, and/or wet cutting mill.

34. The process according to claim 21, wherein
the transfer ply is removed from the carrier film in step x) by means of friction.

35. The process according to claim 21, wherein
the following step is carried out:
x1) separating the carrier film, from the washing liquid.

36. The process according to claim 21, wherein
the following step is carried out:
x2) separating the transfer ply, from the washing liquid.

37. The process according to claim 21, wherein
the transfer ply, is removed from the washing liquid in step x2) by means of at least one thermal and/or mechanical separating process.

38. The process according to claim 21, wherein
the following step is carried out:
x3) separating the detachable detachment layer dissolved in the washing liquid from the washing liquid.

39. The process according to claim 21, wherein
after step x1) and/or after step x2) and/or after step x3) the washing liquid is fed in again as starting liquid for step x).

40. The process according to claim 21, wherein
the process is carried out in a roll-to-roll process.

41. The process according to claim 21, wherein
the process has the following step before step x):
x11) unwinding the transfer product (1) from a feed roll by means of a feed device, wherein the unwound transfer product is brought into contact with the washing liquid.

42. The process according to claim 21, wherein
the process has the following step after step x):
x12) winding the carrier film onto a take-up roll.

43. (canceled)

44. The process according to claim 21, wherein
the following step is carried out before step x):
a) shredding the transfer product by means of a shredder or a shredding device into transfer product shreds.

45-48. (canceled)

49. The process according to claim 21, wherein
the transfer ply is at least partially removed from the carrier film in step a) during the shredding of the transfer product, and thus a mixture of transfer product shreds and/or carrier film shreds and/or transfer ply constituents results.

50-51. (canceled)

52. The process according to claim 21, wherein
the transfer product shreds, after step a) and/or before step x) have a mass in the range of from 0.01 mg to 100 mg.

53. The process according to claim 21, wherein
the following step is further performed before step x):
c) mechanically cleaning the transfer product shreds, by machine, in order to remove foreign materials and/or at least some of the transfer ply constituents.

54-55. (canceled)

56. The process according to claim 21, wherein
the process comprises the following step:
b) compressing the transfer product shreds, into a compact product or extruding the transfer product shreds, into an extrusion product.

57. The process according to claim 21, wherein
the compressing is effected in step b) by means of agglomerating.

58. The process according to claim 21, wherein
the transfer product shreds, are compacted and/or compressed during the compressing in step b), in order to provide a compact product with a higher bulk density.

59. The process according to claim 21, wherein
the following step is further performed before the extruding in step b):
shredding and/or mixing and/or heating and/or drying and/or degassing and/or compressing and/or buffering the transfer product shreds, in a cutter compactor.

60. The process according to claim 21, wherein
the transfer product shreds, are plasticized and homogenized during the extruding in step b) by means of an extruder system.

61-69. (canceled)

70. The process according to claim 21, wherein
the carrier film or the material of the carrier film after step x), and the compact product and/or extrusion product, is suitable for at least one subsequent process or a combination of processes selected from: injection molding, extrusion, pressing processes, compounding, chemical recycling and/or energy recovery.

71-86. (canceled)
